(19) United States
(12) Patent Application Publication
(10) Pub. No.: US 2026/0199923 A1
(43) Pub. Date: Jul. 16, 2026

(54) FLUID SPRAY TIP ASSEMBLY

(71) Applicant: Graco Minnesota Inc., Minneapolis, MN (US)

(72) Inventors: Diane L. Olson, Elk River, MN (US); Christopher C. Hines, Andover, MN (US); Robert W. Kinne, Andover, MN (US); Andrew J. Ericson, Andover, MN (US)

(21) Appl. No.: 19/137,607

(22) PCT Filed: Dec. 11, 2023
(86) PCT No.: PCT/US2023/083430

§ 371 Date: Jun. 10, 2025

Related U.S. Application Data
(60) Provisional application No. 63/432,601, filed on Dec. 14, 2022.

(51) Int. Cl. B05B 15/534; B05B 9/01

(52) U.S. Cl. CPC B05B 15/534; B05B 9/01

(57) ABSTRACT

A fluid spray tip assembly (25) includes a spray tip (26) and a saddle seal portion (36) disposed upstream of the spray tip (26). The spray tip (26) is configured to atomize spray fluid and the saddle seal portion (36) seals with a barrel (38) of the spray tip (26) and defines a flowpath between an upstream valve (78) and the spray tip (26). The saddle seal portion (36) includes a non-elastomeric inner seal (48) that defines a portion of an upstream flowpath and that seals with a seal body (46) that defines a portion of the upstream flowpath and that seals with the barrel (38) of the spray tip (26).

### CROSS-REFERENCE TO RELATED APPLICATION(S)

This application claims priority to U.S. Provisional Application No. 63/432,601 filed Dec. 14, 2022 and entitled “FLUID SPRAY TIP ASSEMBLY,” the disclosure of which is hereby incorporated by reference in its entirety.

### BACKGROUND

The present disclosure relates generally to fluid spray systems and parts thereof. More particularly, this disclosure relates to spray gun and tip assemblies for spray guns.

Fluid sprayers include pumps that pressure spray fluid and drive the spray fluid to a nozzle for outputting the spray fluid as an atomized fluid spray. Fluid sprayers include spray guns that can be held and manipulated by the user. The spray guns typically receive paint or other coating fluid under pressure and atomize the spray fluid. The spray fluid is typically put under pressure by a piston or diaphragm, which is referred to as airless spray. Airless spray can typically range in pressure from about 500 pounds per square inch (psi) (about 3.45 Megapascal (MPa)) to about 7000 psi (about 48.26 MPa), however lower and higher pressures are possible. Due to the action of the piston or the diaphragm, uneven spray patterns can be developed, particularly on stopping and starting of spray or due to cyclical directional reversing of the piston or diaphragm. For example, internal chambers within the flowpath may contain pockets of spray fluid through which pressure waves can reverberate or otherwise echo and cause uneven spray patterns.

### SUMMARY

According to an aspect of the disclosure, a spray tip assembly through which a spray coating flows along an axis from an upstream direction to a downstream direction includes a spray tip and a saddle seal portion. The spray tip includes a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal. The saddle seal portion includes an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion further includes a seal body, wherein the seal body is metallic; and an inner seal in contact with the seal body, wherein the inner seal is non-elastomeric. The inner seal defining a first part of the upstream flow path and at least part of the upstream end, the seal body defining a second part of the upstream flow path disposed downstream of the first part of the upstream flowpath. The downstream end includes a saddle surface that mates to the barrel to cover the spray tip inlet and fluidly connect the upstream flow path to the spray tip inlet, the saddle surface remaining engaged with the barrel as the spray tip is rotated for clog removal.

According to an additional or alternative aspect of the disclosure, a spray tip module includes a tip housing defining a barrel bore extending along a mount axis and defining a housing bore extending fully through the tip housing along the flow axis and transversely through the barrel bore and a spray tip assembly. The spray tip assembly includes a spray tip and a saddle seal portion. The spray tip includes a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal. The saddle seal portion includes an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion further includes a seal body, wherein the seal body is metallic; and an inner seal in contact with the seal body, wherein the inner seal is non-elastomeric. The inner seal defining a first part of the upstream flow path and at least part of the upstream end, the seal body defining a second part of the upstream flow path disposed downstream of the first part of the upstream flowpath. The downstream end includes a saddle surface that mates to the barrel to cover the spray tip inlet and fluidly connect the upstream flow path to the spray tip inlet, the saddle surface remaining engaged with the barrel as the spray tip is rotated for clog removal. The spray tip is rotatably mountable in the barrel bore and the saddle seal portion is disposed within the housing bore at a location upstream of the barrel bore.

According to another additional or alternative aspect of the disclosure, a spray gun includes a spray control assembly having a gun body; a trigger; and a valve assembly having a valve that opens to release spray fluid and closes to block spray fluid, the valve assembly comprising a valve outlet aperture disposed downstream of the valve; and a spray tip module. The spray tip module includes a spray tip assembly and a tip housing. The spray tip assembly includes a spray tip and a saddle seal portion. The spray tip includes a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal. The saddle seal portion includes an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion further includes a seal body, wherein the seal body is metallic; and an inner seal in contact with the seal body, wherein the inner seal is non-elastomeric. The inner seal defining a first part of the upstream flow path and at least part of the upstream end, the seal body defining a second part of the upstream flow path disposed downstream of the first part of the upstream flowpath. The downstream end includes a saddle surface that mates to the barrel to cover the spray tip inlet and fluidly connect the upstream flow path to the spray tip inlet, the saddle surface remaining engaged with the barrel as the spray tip is rotated for clog removal. The tip housing supports the spray tip and at least the seal body of the saddle seal portion. The inner seal seals with the valve assembly about the valve outlet aperture.

According to yet another additional or alternative aspect of the disclosure, a spray gun includes a spray control assembly having a gun body; a trigger; and a valve assembly having a valve that opens to release spray fluid and closes to block spray fluid, the valve assembly comprising a valve outlet aperture disposed downstream of the valve; and a spray tip module. The spray tip module includes a spray tip assembly and a tip housing. The spray tip assembly includes a spray tip and a saddle seal portion. The spray tip includes a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal. The saddle seal portion includes an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion further includes a seal body, wherein the seal body is metallic; and an inner seal in contact with the seal body, wherein the inner seal is non-elastomeric. The inner seal defining a first part of the upstream flow path and at least part of the upstream end, the seal body defining a second part of the upstream flow path disposed downstream of the first part of the upstream flowpath. The downstream end includes a saddle surface that mates to the barrel to cover the spray tip inlet and fluidly connect the upstream flow path to the spray tip inlet, the saddle surface remaining engaged with the barrel as the spray tip is rotated for clog removal. The tip housing supports the spray tip and at least the seal body of the saddle seal portion. The inner seal is formed by a portion of the valve housing such that the seal body interfaces with the valve housing to form an upstream face seal.

According to yet another additional or alternative aspect of the disclosure, a spray gun through which a spray coating flows along an axis from an upstream direction to a downstream direction includes a gun body; a trigger; a valve assembly including a valve which opens to release spray fluid and closes to block spray fluid, the valve assembly comprising a downstream end, a valve outlet aperture located on the downstream end, and a recess formed on the downstream end; a tip housing having a housing bore extending along the spray axis; a spray tip, the spray tip comprising a barrel and a tunnel extending transversely through the barrel, a downstream flowpath extending within the tunnel, the downstream flowpath defined in part by a tip piece located within the tunnel, the tip piece forming an outlet orifice that atomizes spray fluid, the downstream flowpath having a spray tip inlet, the downstream flowpath aligned along the spray axis such that the spray axis extends through the downstream flowpath, the barrel insertable into the tip housing, the spray tip rotatable while the barrel is within the tip housing to reverse a direction of flow through the downstream flowpath for clog removal; an inner seal received within the recess of the valve assembly, the inner seal defining a first part of an upstream flowpath, the inner seal formed from a non-elastomeric polymer; and a seal body, the seal body defining a second part of the upstream flowpath disposed downstream of the first part of the upstream flowpath, the seal body comprising a saddle surface that mates to the barrel to cover the spray tip inlet and fluidly connect the first part of the upstream flowpath to the spray tip inlet, the saddle surface remaining engaged with the barrel as the spray tip is rotated for clog removal. The inner seal forms a downstream face seal with the seal body to form a fluid channel for the spray fluid from the valve outlet orifice, sequentially through each of the first part of the upstream flowpath, the second part of the upstream flowpath, the downstream flowpath, and out the outlet orifice. The inner seal is retained in the recess of the valve assembly upon separation of the seal body and the inner seal during dismounting of the tip housing.

According to yet another additional or alternative aspect of the disclosure, a spray tip assembly through which a spray coating flows along an axis from an upstream direction to a downstream direction includes a spray tip and a saddle seal portion. The spray tip includes a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal. The saddle seal portion has an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion further includes a seal body; and an inner seal mounted to and supported by the seal body, wherein the inner seal is non-elastomeric. The inner seal includes an inner ring having an upstream face configured to form an upstream face seal in the upstream direction and having a downstream face, the downstream face contacting a seal face of the seal body to form a downstream face seal between the inner seal and the seal body. The inner seal defining a first part of the upstream flow path and at least part of the upstream end, the seal body defining a second part of the upstream flow path disposed downstream of the first part of the upstream flowpath. The downstream end includes a saddle surface that mates to the barrel to cover the spray tip inlet and fluidly connect the upstream flow path to the spray tip inlet, the saddle surface remaining engaged with the barrel as the spray tip is rotated for clog removal.

According to yet another additional or alternative aspect of the disclosure, a spray tip module includes a tip housing defining a barrel bore extending along a mount axis and defining a housing bore extending fully through the tip housing along the flow axis and transversely through the barrel bore; and a spray tip assembly. The spray tip assembly includes a spray tip and a saddle seal portion. The spray tip includes a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal. The saddle seal portion has an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion further includes a seal body; and an inner seal mounted to and supported by the seal body, wherein the inner seal is non-elastomeric. The inner seal includes an inner ring having an upstream face configured to form an upstream face seal in the upstream direction and having a downstream face, the downstream face contacting a seal face of the seal body to form a downstream face seal between the inner seal and the seal body. The inner seal defining a first part of the upstream flow path and at least part of the upstream end, the seal body defining a second part of the upstream flow path disposed downstream of the first part of the upstream flowpath. The downstream end includes a saddle surface that mates to the barrel to cover the spray tip inlet and fluidly connect the upstream flow path to the spray tip inlet, the saddle surface remaining engaged with the barrel as the spray tip is rotated for clog removal. The spray tip is rotatably mountable in the barrel bore and the saddle seal portion is disposed within the housing bore at a location upstream of the barrel bore.

According to yet another additional or alternative aspect of the disclosure, a spray gun includes a gun body; a trigger; a valve assembly having a valve disposed within a valve housing, the valve opening to release spray fluid and closing to block spray fluid, the valve assembly comprising a valve outlet aperture disposed downstream of the valve; a tip housing having a barrel bore extending along a tip axis and a housing bore extending through the tip housing and barrel bore, the tip housing extending along a flow axis; a spray tip, the spray tip comprising a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the flow axis such that the flow axis extends through the downstream flow path, and the spray tip rotatable on the tip axis to reverse a direction of flow through the downstream flow path for clog removal; and a saddle seal portion having an upstream end, a downstream end, and an upstream flow path extending through the saddle seal portion from a portion inlet on the upstream end to a portion outlet on the downstream end, the upstream flow path aligned along the axis such that the axis extends through the upstream flow path. The saddle seal portion includes a seal body, wherein the seal body is metallic; and an inner seal in contact with the seal body, wherein the inner seal is non-elastomeric. The inner seal defining a first part of the upstream flow path and at least part of the upstream end, the seal body defining a second part of the upstream flow path disposed downstream of the first part of the upstream flowpath. The downstream end comprising a saddle surface that mates to the barrel to cover the spray tip inlet and fluidly connect the upstream flow path to the spray tip inlet, the saddle surface remaining engaged with the barrel as the spray tip is rotated for clog removal. The inner seal is formed by a portion of the valve housing such that the seal body interfaces with the valve housing to form an upstream face seal.

According to yet another additional or alternative aspect of the disclosure, a method of flowing spray fluid for atomization and spraying includes emitting spray fluid from a valve housing aperture formed in a valve housing and into an upstream flowpath through a spray tip assembly; flowing the spray fluid through a first part of an upstream flowpath within the spray tip assembly to a second part of the upstream flowpath, the first part defined by an inner seal formed from a non-elastomeric polymer, the second part formed by a seal body having an upstream seal face interfacing with the inner seal at a downstream face seal; flowing the spray fluid to a downstream flowpath within a tunnel extending transversely through a barrel of a spray tip, the downstream flowpath defined in part by a tip piece located within the tunnel, the tip piece forming an outlet orifice that atomizes spray fluid wherein the spray tip is rotatable to reverse a direction of flow through the downstream flowpath for clog removal, wherein a downstream end of the seal body comprises a saddle surface that mates to the barrel to cover a spray tip inlet of the downstream flowpath and fluidly connect the upstream flowpath to the spray tip inlet, the saddle surface remaining engaged with the barrel as the spray tip is rotated for clog removal; and flowing the spray fluid through the outlet orifice to atomize the spray fluid into a fluid spray.

### BRIEF DESCRIPTION OF THE DRAWINGS

FIG. 1 is an isometric view of a spray gun.

FIG. 2 is a partially exploded isometric view of the spray gun shown in FIG. 1.

FIG. 3A is a first isometric exploded view of a portion of a spray tip module.

FIG. 3B is a cross-section taken along line B-B in FIG. 3A.

FIG. 4A is a second isometric exploded view of the portion of the spray tip module shown in FIG. 3A.

FIG. 4B is a cross-sectional view taken along line B-B in FIG. 4A.

FIG. 5A is a cross-sectional view taken along line 5-5 in FIG. 1.

FIG. 5B is an enlarged view of detail B in FIG. 5A.

FIG. 5C is an enlarged view of detail C in FIG. 5A.

FIG. 6A is an isometric view of a downstream side of a portion of a spray gun.

FIG. 6B is an isometric view showing a ring exploded away from the portion of the spray gun.

FIG. 7 is an isometric view of a spray gun.

FIG. 8 is a partially exploded isometric view of the spray gun shown in FIG. 7.

FIG. 9A is an enlarged cross-sectional view taken along line 9-9 in FIG. 7.

FIG. 9B is an enlarged view of detail B in FIG. 9A.

FIG. 10 is a cross-sectional view showing an interface between a spray gun and spray tip module.

FIG. 11 is a cross-sectional view showing an example assembly.

### DETAILED DESCRIPTION

The present disclosure relates to fluid sprayers. Fluid sprayers according to the disclosure include a pump that pressurizes a spray fluid, such as paint, varnishes, lacquer, finishes, and other coatings, among other options, and drives the spray fluid through a conduit, such as a hose, to an applicator, such as a spray gun. The spray gun includes a spray valve that is actuatable between a closed state and an open state to control emission of spray fluid from the spray gun. A tip assembly is disposed downstream of the valve. The tip assembly receives the spray fluid and is configured to atomize the spray fluid into a fluid spray. The tip assembly includes a saddle seal portion that at least partially defines a flowpath of the spray fluid upstream of the spray orifice.

Saddle seal portions according to aspects of the disclosure include an inner seal disposed directly axially between a seal body configured to mate with a barrel and a housing face of an upstream valve housing. The inner seal defines a portion of a tip flowpath through the tip assembly and bridges an axial gap between the seal body and the housing face. The inner seal defines a first part of an upstream flowpath through the saddle seal portion and the seal body defines a second part of the upstream flowpath through the saddle seal portion. The relative diameters of the first and second parts of the upstream flowpath are sized to eliminate expansion pockets that may generate pressure echoes and reflect pressure waves. Elimination of such expansion pockets provides for generation of smooth fluid flow and application of a smooth coat of atomized spray fluid. The tip assemblies of the present disclosure can eliminate internal echo pockets to provide for a smoother spray pattern, which is desirable in painting and other coating applications.

Inner seals according to the present disclosure bridge between the seal body and the valve housing to eliminate expansion pockets. The inner seals are non-elastomeric, which may further resist propagation of pressure echoes. The inner seals bridge between the seal body and the valve housing and generate an axial gap therebetween. The inner seal prevent contact between a tip housing supporting the seal body and the valve housing, preventing wear on those components and assisting in concentrically aligning the flow defining components along an axis along which the spray fluid flows.

Components can be considered to radially overlap when those components are disposed at common axial locations along an axis and such that a line extending radially from the axis will extend through each of the radially overlapping components. Components can be considered to axially overlap when those components are disposed at common radial and circumferential locations relative to an axis such that an axial line parallel to the axis extends through each of the axially overlapping components. Components can be considered to circumferentially overlap when aligned about the axis at a common radial distance from the axis such that a circle centered on the axis passes through each of the circumferentially overlapping components.

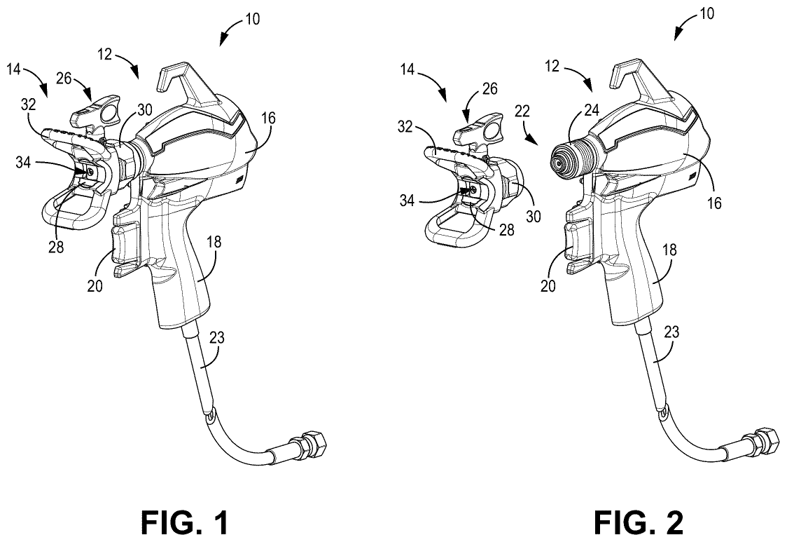

FIG. 1 is an isometric view of spray gun 10. FIG. 2 is a partially exploded isometric view of spray gun 10. FIGS. 1 and 2 are discussed together. Spray gun 10 includes spray control assembly 12 and tip module 14. Spray control assembly 12 includes gun housing 16, handle 18, trigger 20, valve assembly 22, and housing mount 24. Spray tip 26, tip housing 28, tip mount 30, and guard 32 of tip module 14 are shown.

Spray gun 10 is configured to control flow of pressurized spray fluid to tip assembly 25. Tip module 14 is configured to receive the spray fluid from the spray control assembly 12 and includes spray orifice 34 that is shaped to atomize the spray fluid into a spray pattern that is output from spray gun 10. Spray gun 10 includes an internal valve that is actuated to an open state to allow flow of spray fluid to flow to and through spray orifice 34 and that is actuated to a closed state to stop flow of the spray fluid to and through the spray orifice 34.

Gun housing 16 supports other components of spray gun 10. Handle 18 is formed on a bottom side of gun housing 16. In the example shown, handle 18 is formed monolithically with gun housing 16, though it is understood that not all examples are so limited. Handle 18 and gun housing 16 can be considered to form a body of spray gun 10. Handle 18 depends from a bottom side of gun housing 16 in the example shown.

Trigger 20 is disposed forward of handle 18 in the example shown. Trigger 20 is configured to control actuation of the internal valve between open and closed states. Actuation of the trigger 20 causes the spray gun 10 to release spray fluid from the spray orifice 34 and release of the trigger 20 causes the spray gun 10 to cease release of spray fluid from the spray orifice 34. Fluid hose 23 is configured to provide the spray fluid to spray gun 10 under pressure. Fluid hose 23 can extend into spray gun 10 through a lower side of handle 18. While spray gun 10 is shown as including a hose 23 configured to provide spray fluid to spray gun 10 under pressure, it is understood that not all examples are so limited. For example, spray gun 10 can be configured to support a reservoir containing spray fluid and have a pump disposed within the gun housing 16.

Tip module 14 is mountable to and dismountable from spray control assembly 12. Spray tip 26 is supported by tip housing 28. Spray tip 26 includes spray orifice 34 that is configured to atomize the spray fluid. Spray tip 26 can be rotatably mounted to tip housing 28 such that spray tip 26 can be rotated to reverse flow through spray tip 26 (such that fluid enters spray tip 26 through spray orifice 34), such as for clog removal. In the example shown, spray tip 26 is removable from tip housing 28 and is reversible while remaining mounted in tip housing 28.

In the example shown, tip mount 30 is interfaced with housing mount 24 to mount tip housing 28 to spray control assembly 12. In the example shown, tip mount 30 receives housing mount 24 to connect tip module 14 to other components of spray gun 10. Tip mount 30 can be a rotatable portion of tip housing 28 that is configured to interface with housing mount 24 to mount tip assembly 25. Tip mount 30 can be formed as a threaded connector. The housing mount 24 can be part of a gun housing 16 and/or valve assembly 22, amongst other options. In the example shown, the housing mount 24 is threaded complementary to internal threading of the tip mount 30 to facilitate mounting and secure attachment of the spray tip housing 28. In some examples, tip mount 30 is formed as a female threaded connector, though it is understood that not all examples are so limited. The housing mount 24 can be formed as a male threaded connector, though it is understood that not all examples are so limited. In the example shown, the housing mount 24 is received within tip mount 30 to mount tip module 14 to spray control assembly 12. In the example shown, housing mount 24 is formed by valve housing 59 of valve assembly 22. However, in various other examples, the housing mount 24 is separate from the valve assembly 22.

In the example shown, housing mount 24 is formed on a portion of valve housing 59 that projects outwards from gun housing 16. It is understood that valve housing 59 can be formed as or as part of a cartridge that is removable from the gun housing 16 as a single unit. Removal of the cartridge can also remove valving components, such as a needle and seat, from the gun housing 16.

The valve assembly 22 is part of the spray gun 10 and includes the internal valve that opens to release spray fluid to the spray tip 26 and closes to cease release of spray fluid. It is noted that, in some examples, the valve assembly 22 can be a cartridge that is removable from gun housing 16. The valve assembly 22 can be partially located within a gun housing 16 of the spray gun 10, however other options are possible. In some examples, valve assembly 22 can be mounted to gun housing 16 by interfaced threading (e.g., on an exterior of valve housing 59 and interior of a bore within gun housing 16). In some examples, tip module 14 can hold valve assembly 22 within gun housing 16 by an interface between tip mount 30 and a housing mount 24, such as a housing mount 24 formed at least partially by gun housing 16.

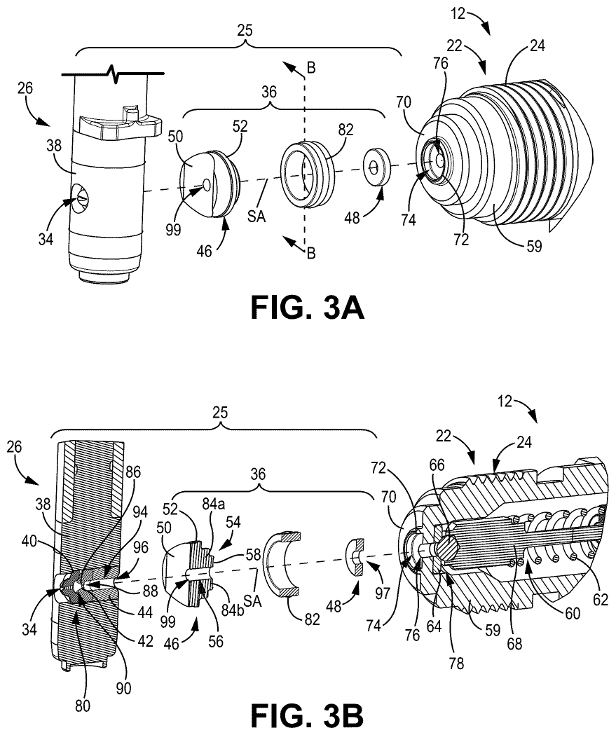

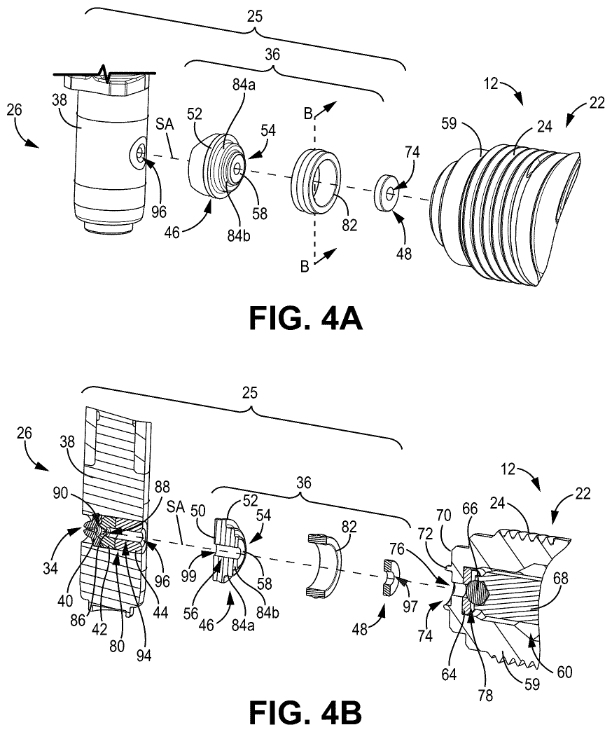

FIG. 3A is an isometric exploded view showing a portion of tip module 14. FIG. 3B is a cross-sectional view taken along line B-B in FIG. 3A. FIG. 4A is another isometric exploded view of the portion of tip module 14 shown in FIG. 3A. FIG. 4B is a cross-sectional view taken along line B-B in FIG. 4A. FIGS. 3A-4B are discussed together. Spray tip 26 and saddle seal portion 36 of tip module 14 are shown. Tip barrel 38, tip piece 40, pre-orifice piece 42, and retainer 44 of spray tip 26 are shown. Saddle seal portion 36 includes seal body 46 and inner seal 48. Seal body 46 includes saddle face 50, body projection 54, body bore 56, and seal face 58. Valve assembly 22 and housing mount 24 of spray control assembly 12 are shown. Valve housing 59, needle 60, valve spring 62, seat 64, housing face 70, support ring 72, valve outlet aperture 76, and valve 78 of valve assembly 22 are shown.

Barrel 38 of spray tip 26 is configured to mount within barrel bore 100 within tip housing 28. The barrel 38 can be cylindrical. Tip handle 18 (FIGS. 1, 2, and 10) of the spray tip 26 is disposed at one end of barrel 38. Tip handle 18 can be formed of polymer while the barrel 38 can be formed from metal, such as aluminum or stainless steel. Tunnel 80 extends transversely through the barrel 38 relative to tip axis TA. Spray tip 26 is configured to rotate on tip axis TA between the spray state and the de-clog state. In the de-clog state, barrel 38 is rotated such that flow through spray tip 26 is reversed relative to flow direction in the spray state.

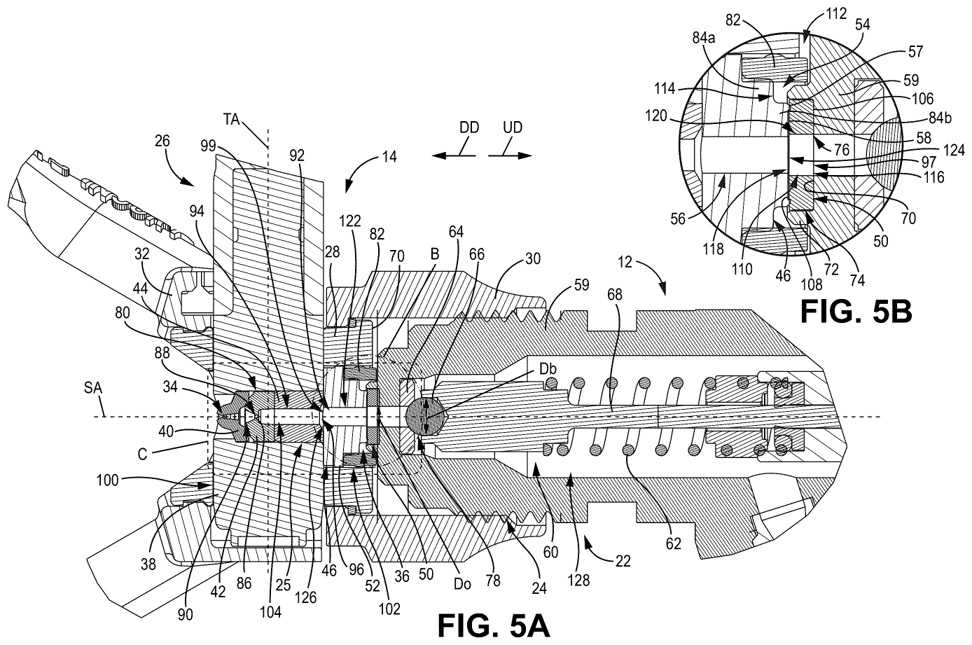

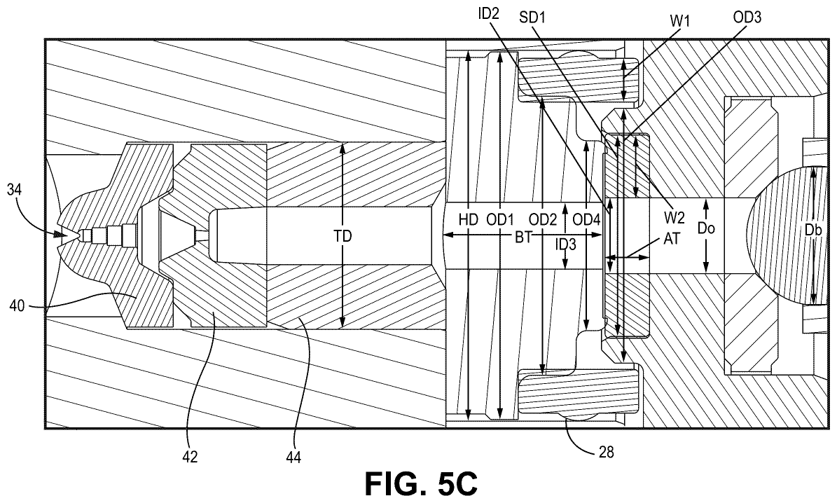

Spray tip 26 is part of tip assembly 25. Tip assembly 25 further includes saddle seal portion 36. Spray tip 26 and saddle seal portion 36 form tip assembly 25. While omitted in FIGS. 3A-4B for clarity, spray tip 26 and at least some components of saddle seal portion 36 are supported by tip housing 28 (best seen in FIG. 5A).

Saddle seal portion 36 includes seal body 46. Seal body 46 can be metallic, among other options. Saddle face 50 is formed as a face of seal body 46 oriented in downstream direction DD along spray axis SA. Saddle face 50 is formed as a curved downstream surface that interfaces with the barrel 38. Saddle face 50 is curved to be complementary to the cylindrical profile the barrel 38 to seal when mated. Barrel 38 can move relative to saddle face 50 while within the saddle defined by saddle face 50 as spray tip 26 rotates between the positions associated with the spray and de-clog states. The shape of the curved exterior surface of the barrel 38 and the downstream saddle face 50 are complementary to seal with one another. It is noted that such sealing can be by metal-to-metal contact between a metallic seal body 46 and a metallic barrel 38. For example, seal body 46 can be formed from aluminum or stainless steel, among other options.

Shoulder 52 is a radially enlarged portion of seal body 46. In the example shown, shoulder 52 extends annularly about spray axis SA. Shoulder 52 is disposed in upstream direction UD from the portion of seal body 46 that forms saddle face 50. Shoulder 52 can be formed as a cylindrical ring that projects radially outward relative to other portions of seal body 46.

In the example shown, seal body 46 includes body projection 54 that extends in upstream direction UD from other portions of seal body 46. The largest outer diameter OD2 of body projection 54 is smaller than the largest outer diameter OD1 of seal shoulder 52. Body projection 54 can be disposed concentrically with shoulder 52. In some examples, shoulder 52, such as an upstream end of shoulder 52, and body projection 54, such as a downstream end of body projection 54, can have concentric circular cross-sections orthogonal to the spray axis SA.

In the example shown, body projection 54 is formed as a multi-step projection. Body projection 54 includes downstream projection 84a and upstream projection 84b. Projection 84a extends from shoulder 52 in upstream direction UD. Projection 84b extends from projection 84a in upstream direction UD. Projections 84a, 84b can be configured to interface with and seal against other components, as discussed in more detail below. Projections 84a, 84b can be configured as concentric cylindrical projections. It is understood that, while body projection 54 is shown as including multiple steps, not all examples are so limited. For example, body projection 54 can include a single cylindrical step, a sloped face for at least a portion of the distance between the downstream end of body projection 54 and seal face 58, a frustoconical portion between the downstream end of body projection 54 and seal face 58, no reduction in diameter, a combination of cylindrical and sloped portions, among other options.

Body projection 54 can be narrower than the widest part of the seal body 46, with respect to a direction that is orthogonal to the indicated axis. In the example shown, shoulder 52 forms a radially widest portion of seal body 46 along spray axis SA and body projection 54 is radially narrower than the shoulder 52. Body projection 54 can be received within the outer ring 82. In some examples, an upstream portion of body projection 54 (e.g., projection 84b) can be received within inner seal 48 and/or receive a portion of inner seal 48 so that body projection 54 and inner seal 48 radially overlap, though in other examples body projection 54 does not radially overlap with inner seal 48. In the example shown, the inner seal 48 does not radially overlap with the seal body 46. In some examples, inner seal 48 does not radially overlap with seal face 50.

Saddle seal portion 36 can, in some examples, further include outer polymer ring 82. It is noted that not all examples of saddle seal portion 36 include outer polymer ring 82. The outer polymer ring 82 can receive body projection 54 to cause an interference fit to retain the outer polymer ring 82 on the seal body 46. In the example shown, projection 84a is configured to extend into and interface with an inner radial side of outer polymer ring 82. Body projection 54 extends into outer polymer ring 82 to radially overlap with outer polymer ring 82. Projection 84a can have an interference fit with outer polymer ring 82 to mount outer polymer ring 82 to seal body 46. While saddle seal portion 36 is shown as including outer polymer ring 82, it is understood that not all examples are so limited and outer polymer ring 82 may be omitted in some examples.

Shoulder 52 of seal body 46 can interface with a downstream end of outer polymer ring 82 to brace against outer polymer ring 82. Shoulder 52 can axially locate outer polymer ring 82 on spray axis SA. Shoulder 52 can brace against outer polymer ring 82 and limit displacement of outer polymer ring 82 relative to seal body 46 in downstream direction DD. Outer ring 82 can be formed as an elastomeric or non-elastomeric material.

Saddle seal portion 36 includes inner seal 48. Inner seal 48 can be considered to form a part of tip assembly 25 even if separate from tip module 14 such that a portion of tip assembly 25 is part of tip module 14 And a part of tip assembly 25 is part of spray control assembly 12. Inner seal 48 defines at least a part of an upstream end of saddle seal portion 36. It is noted in some examples that inner seal 48 can be considered to be part of valve assembly 22 while still forming a part of tip assembly 25. In such an example the inner seal 48 can remain mounted to valve assembly 22 while other components of saddle seal portion 36 are dismounted from valve assembly 22. In other examples, inner seal 48 is mountable with and dismountable with other components of saddle seal portion 36. For example, inner seal 48 can be mounted to seal body 46 to mount to valve assembly 22 with tip module 14 and dismount from valve assembly 22 with tip module 14. In some examples, inner seal 48 can be formed monolithically with other components of valve assembly 22. For example, inner seal 48 can be formed by portions of the housing of valve assembly 22, as discussed in more detail below. Aspects of various configurations are further discussed herein, including without necessarily pointing out which particular aspect applies to which particular example, as aspects are assumed to apply to both unless otherwise noted.

Inner seal 48 is non-elastomeric. For example, inner seal 48 can be formed from polymer, metal (e.g., stainless steel, among other options), ceramic, etc. In examples in which inner seal 48 is formed from a polymer, inner seal 48 may be polyamide (Nylon), UHMWPE, acetal, amongst other options. Inner seal 48 is not elastomeric. Inner seal 48 may not be formed from rubber. The inner seal 48 may be of a material that does not take the compression set during spray pressures. As discussed in more detail below, some examples include inner seal 48 that is monolithically formed with a portion of valve housing 59 and other examples include inner seal 48 formed separately from valve housing 59. Inner seal 48 can be formed separately from seal body 46 and can be normally engaged with seal body 46 or can move into engagement with seal body 46 during mounting of tip module 14.

Seal body 46 extends to interface with and seal against inner seal 48. In the example shown, seal body 46 and inner seal 48 axially engage along spray axis SA. The interface between seal body 46 and inner seal 48 forms a face seal. The face seal between inner seal 48 and seal body 46 can also be referred to as a downstream face seal as such a seal is formed with a downstream side of inner seal 48.

Seal face 58 of seal body 46 interfaces with the downstream face of inner seal 48 to form the face seal therebetween. In the example shown, body projection 54 is configured to interface with inner seal 48 to form the face seal with inner seal 48. In the example shown, projection 84b extends axially in the upstream direction UD to engage with and seal against inner seal 48. In some examples, seal face 58 includes a planar portion orthogonal to axis SA and includes a mate ring 57 that projects in upstream direction UD and interfaces with inner seal 48. It is understood that some examples of seal face 58 do not include a mate ring 57. Mate ring 57 interfacing with inner seal 48 can assist in concentric interfacing of seal body 46 and inner seal 48.

Saddle seal portion 36 is configured to receive spray fluid into tip flowpath 92 (FIG. 5A) through tip assembly 25. Saddle seal portion 36 receives spray fluid output from valve 78 and fluidly connects valve 78 and the downstream flowpath 94 through spray tip 26. Saddle seal portion 36 defines upstream flowpath 98 (FIGS. 5A and 5B). Upstream flowpath 98 extends between portion inlet 97 and portion outlet 99. Saddle seal portion 36 receives spray fluid through portion inlet 97 and outputs the spray fluid through portion outlet 99. Portion inlet 97 is defined by inner seal 48 and portion outlet 99 is defined by seal body 46. Portion inlet 97 is formed though an upstream face of inner seal 48. Portion outlet 99 is formed through saddle face 50. Upstream flowpath 98 extends along axis SA. Axis SA extends through upstream flowpath 98. Upstream flowpath 98 can be disposed coaxially with valve outlet aperture 76.

Tip assembly 25 is configured to mount to valve assembly 22. One or more of the components of tip assembly 25 are configured to removably mount to valve assembly 22. As discussed above, valve assembly 22 can be formed as a cartridge that is mountable to and removable from gun body 16. The valve housing 59 can be connected to gun body 16, such as within a bore within gun body 16, in any desired manner, such as by threading, by a bayonet connection, among other options. In such an example, removing the cartridge forming valve assembly 22 from gun body 16 also removes valving components, such as needle 60 and seat 64.

Housing face 70 of valve housing 59 is oriented in downstream direction DD. Valve outlet aperture 76 is formed through housing face 70 and forms an opening through which spray fluid can exit from valve housing 59. Needle 60 and valve seat 64 of valve 78 are shown. Needle 60 moves along spray axis SA relative to valve seat 64 to open and close the flowpath through valve 78. In the example shown, ball 66 is supported by stem 68, which ball 66 and stem 68 together form needle 60. Ball 66 engages with seat 64 to close valve 78 and is disengaged from seat 64 to open valve 78. Spring 62 is configured to bias ball 66 into engagement with seat 64.

Recess 74 is formed on valve housing 59. Recess 74 is configured to receive inner seal 48 such that inner seal 48 is at least partially disposed in recess 74. Inner seal 48 can be fully disposed within recess 74 such that a full axial length of inner seal 48 is radially overlapped by structure defining recess 74. In other examples inner seal 48 can project axially out of recess 74 such that inner seal 48 is partially radially overlapped by structure defining recess 74 and partially not radially overlapped by structure defining recess 74.

Recess 74, which can also be referred to as a seal chamber, is a downstream recess at a downstream end of valve housing 59. In the example shown, the recess 74 is at least partially formed by support ring 72 projecting from housing face 70. The recess 74 is formed within the support ring 72 and is radially defined by the support ring 72 in the example shown. It is understood that in various examples the recess 74 can be formed by a depression into the downstream face of valve housing 59.

In the example shown in FIGS. 3A-4B, valve housing 59 includes support ring 72 that defines recess 74. Support ring 72 is configured to radially support inner seal 48. In the example shown, support ring 72 projects axially in downstream direction DD from housing face 70. Support ring 72 forms an annular projection that defines a recess 74 within which inner seal 48 is at least partially disposed to mount inner seal 48 to valve housing 59. Support ring 72 can, in some examples, for a downstream-most structure of the valve housing 59. It is understood that, while support ring 72 is shown as a projecting ring (e.g., housing face 70 is spaced upstream from support ring 72 on both radial sides of support ring 72), not all examples are so limited. For example, recess 74 can extend into housing face 70 such that recess 74 extends in upstream direction UD relative to portions of housing face 70. In such an example the support ring 72 can be considered to not project relative to housing face 70. In such an example no portion of housing face 70 may extend radially outward of the support ring 72. Support ring 72 is formed such that valve outlet aperture 76 is aligned through support ring 72. Valve outlet aperture 76 and support ring 72 can be disposed coaxially on spray axis SA. Tunnel 80 extends transversely through barrel 38. Tunnel 80 extends through tip axis TA in the example shown. Tip axis TA can intersect and be orthogonal to the spray axis SA.

Located within the tunnel 80 can be one or more spray components. The spray components include a tip piece 40 defining spray orifice 34 for atomizing the spray fluid. In the example shown, the spray components of spray tip 26 includes retainer 44, pre-orifice piece 42, and tip piece 40. Retainer 44 is located within the tunnel 80. Retainer 44 is configured to hold other of spray components within tunnel 80. It is understood that a retainer 44 may not be included in various other examples. Included in the tunnel 80 is pre-orifice piece 42. It is noted that not all examples may include a pre-orifice piece 42. The pre-orifice piece 42 includes an orifice wall 86. Orifice wall 86 extends radially inwards towards the spray axis SA. Pre-orifice aperture 88 extends through orifice wall 86. Pre-orifice aperture 88 is configured to significantly restrict the flow path through the pre-orifice piece 42. In some examples, pre-orifice aperture 88 forms a smallest diameter portion of the flowpath through the spray tip 26. In some examples, the pre-orifice aperture 88 forms a smallest cross-sectional flow area orthogonal to the spray axis SA through spray tip 26. In some examples, the pre-orifice aperture 88 forms a smallest cross-sectional flow area orthogonal to the spray axis SA through spray tip 26 except for spray orifice 34. The orifice wall 86 can extend radially inward to form a flow restriction (the pre-orifice aperture 88) which narrows the downstream flowpath 108 along the orifice wall 86 to be narrower than any part of the upstream flowpath 106, the downstream flowpath 108 including a pre-wall path portion 104 beginning at the spray tip inlet 96 and terminating at the orifice wall 86.

The spray tip 26 further includes a tip piece 40 located within the tunnel 80. The tip piece 40 defines the spray orifice 34 which is a narrowing flow passage that causes atomization of the spray fluid into a fan or other shape. The spray orifice 34 can be of a cat-eye shape, among other options. In examples with a pre-orifice piece 42, a turbulation chamber 90 is formed between respective orifice walls of the pre-orifice piece 42 and the tip piece 40. The smallest inner diameter along the flow path through the aperture of the pre-orifice piece 42 and/or tip piece 40 can be in the range of 0.075-0.150 inches (in.) (about 0.19-0.38 centimeters (cm)), although larger and smaller sizes are possible.

Within the tunnel 80 is downstream flowpath 94. Downstream flowpath 94 is defined by the spray components within tunnel 80 in the example shown. Downstream flowpath 94 extends from spray tip inlet 96 to the spray orifice 34. While the spray tip inlet 96 is defined by the retainer 44 in the example shown, spray tip inlet 96 can instead be defined by other structure forming whichever orifice forms an inlet for flow into the tunnel 80. With spray tip 26 in a reversed position, the downstream flowpath 94 can receive spray fluid through spray orifice 34 and output spray fluid, and clogs, through spray tip inlet 96. Downstream flowpath 94 can be disposed coaxially with upstream flowpath 98 on spray axis SA.

FIG. 5A is a cross-sectional view taken along line 5-5 in FIG. 1 showing tip module 14 mounted to spray control assembly 12. FIG. 5B is an enlarged view of detail B in FIG. 5A. FIG. 5C is an enlarged view of detail C in FIG. 5A. FIGS. 5A-5C are discussed together and with continued reference to FIGS. 1-4B. Axis SA is indicated, which axis SA generally defines an upstream direction UD and a downstream direction DD along which the spray fluid generally flows from upstream to downstream.

Spray tip 26 can be rotated such that the barrel 38 spins around and reverses flow along the through downstream flowpath 94 along the axis SA to remove clogs. Barrel 38 is rotatable on tip axis TA which is transverse to, and can intersect and be orthogonal to, spray axis SA. Any flow path referenced herein and/or shown in the figures can be cylindrical, coaxial with the axis SA. It is understood that, while components and structure may be described as having a diameter, such a dimension can be formed by shapes other than circular and still be within the scope of the disclosure, unless specifically noted otherwise.

Guard 32 is mounted to and extends from tip housing 28. Guard 32 can be overmolded onto tip housing 28, among other options. The spray tip housing 28 comprises a barrel bore 100 that receives the barrel 38 of the spray tip 26 and allows the spray tip 26 to rotate within the barrel bore 100.

Saddle seal portion 36 includes a portion inlet 97. At least a portion of saddle seal portion 36 is disposed within housing bore 102 to be supported by tip housing 28. In the example shown, seal body 46 is disposed within housing bore 102 and is supported by tip housing 28. Saddle face 50 can be considered to partially define barrel bore 100 in tip housing 28.

The spray fluid enters into saddle seal portion 36 through portion inlet 97. In the example shown, the portion inlet 97 is defined by the inner seal 48. Specifically in this example, the portion inlet 97 is defined as the upstream orifice of the flowpath through the inner seal 48. Saddle seal portion 36 further includes portion outlet 99. The spray fluid exits from saddle seal portion 36 through the portion outlet 99. Specifically in this example, the body outlet 126 through which the spray fluid exits seal body 46 is defined as the downstream orifice 126 of the flowpath through the seal body 46. Body outlet 126 is formed through saddle face 50.

An upstream flowpath 98 is defined through the saddle seal portion 36. For example, the upstream flowpath 98 can be defined by and extend between the portion inlet 97 on an upstream side and the portion outlet 99 on a downstream side. In the example shown, the upstream flowpath 98 is partially radially defined by inner seal 48 and partially radially defined by seal body 46. In some examples, the upstream flowpath 98 is defined only by the inner seal 48 and the seal body 46.

After exiting from the upstream flowpath 94 the spray fluid continues downstream through spray tip 26. The spray fluid enters into a downstream flowpath 94 formed through spray tip 26. The downstream flowpath 94 extends through barrel 38. The downstream flowpath 94 is radially within tunnel 80. The downstream flowpath 94 extends from spray tip inlet 96 to spray orifice 34 with spray tip 26 in the spray position associated with the spray state. The downstream flowpath extends from the spray orifice 34 to the tip inlet 96 with spray tip 26 in the de-clog position associated with the de-clog state.

Pre-wall path portion 104 can be present within the tunnel 80 of the spray tip 26. Pre-wall path portion 104 forms a portion of the downstream flowpath 94 upstream of the pre-orifice aperture 88. The pre-wall path portion 104 can be defined by the spray tip inlet 96 on an upstream side and the orifice wall 86 on a downstream side. The pre-wall path portion 104 forms a portion of the downstream flowpath 94. In the example shown, the pre-wall path portion 104 extends partially within the retainer 44 and partially within the pre-orifice piece 42. The spray tip inlet 96 forms an opening at one axial end of the pre-wall path portion 104 and the pre-orifice aperture 88 forms an opening at an opposite axial end of the pre-wall path portion 104. Downstream flowpath 94 further extends through turbulation chamber 90 and to spray orifice 34.

In some examples, a largest inner diameter of the first part 120 of the upstream flowpath 98 is no greater than two and a half times of a largest inner diameter of the pre-wall path portion 104. In some examples, the largest inner diameter of the first part 120 is no greater than one and a half times of the largest inner diameter of the pre-wall path portion 104. In some examples, an average inner diameter along an entire length of the first part 120 of the upstream flowpath 98 is no greater than two and a half times of an average inner diameter along an entire length of the pre-wall path portion 104. In some examples, an average inner diameter along the entire length of the first part 120 is no greater than one and a half times of the average inner diameter along the entire length of the pre-wall path portion 104.

Tip assembly 25 is mounted to valve assembly 22. Valve outlet aperture 76 is an opening of valve assembly 22 through which spray fluid exits from the spray control assembly 12. In the example shown, valve outlet aperture 76 is defined by valve housing 59, however the valve outlet aperture 76 can be defined by other structures in various other examples.

Valve 78 includes seat 64. The seat 64 is shown as a separate component from the valve housing 59. It is understood, however, that seat 64 may be integrated with the valve housing 59 in various other examples. The seat 64 can be a disc with a central aperture. The seat 64 interfaces with a movable component of the valve. In the example shown, the movable valving component is formed as a needle 60. In this example, the needle 60 is formed as a ball 66 held by a stem 68, the ball 66 interfacing with the seat 64, such as with the material defining the aperture of the seat 64. Ball 66 has a diameter Db that is larger than a diameter Do through valve outlet aperture 76 in the example shown. The valve 78 in this embodiment includes a spring 62 that is overcome by pressure of the spray fluid to open up by the needle 60 lifting from the seat 64, and closes when pressure within the chamber of the valve 78 decreases to no longer overcome the spring so the needle 60 re-engages the seat 64 to close the valve 78 by the spring 62 driving the needle 60 to engage with the seat 64. It is understood, however, that various valving configurations other than ball and seat and/or other than spring return are possible.

Inner seal 48 is disposed between tip assembly 25 and spray control assembly 12 and at least partially defines a portion of tip flowpath 92 for spray fluid upstream of spray orifice 34. The tip pathway 92 can also be referred to as a main flowpath. In the example shown, the main tip pathway 92 including the upstream flowpath 98 and the pre-wall path portion 104 does not include an expansion pocket, the expansion pocket defined as any radial chamber having an average inner diameter greater than two times of an average inner diameter of a total remainder of the tip pathway 92 and having an axial length less than one third of an axial length of the tip pathway 92.

Inner seal 48 at least partially defines the spray fluid flowpath at locations downstream of valve 78 and upstream of downstream flowpath 94. Inner seal 48 is disposed directly axially between seal body 46 and valve housing 59 in the example shown. Inner seal 48 is configured to engage with seal body 46 to form a fluid seal between inner seal 48 and seal body 46. The seal between inner seal 48 and seal body 46 can be formed as a face seal. The seal between inner seal 48 and seal body 46 can be referred to as a downstream face seal. Inner seal 48 is configured to engage with valve housing 59 to form a fluid seal between inner seal 48 and valve housing 59. The seal between inner seal 48 and valve housing 59 can be formed as a face seal. The seal between inner seal 48 and valve housing 59 can be referred to as an upstream face seal.

In the example shown, inner seal 48 is at least partially disposed within recess 74. In some examples, inner seal 48 can project axially out of recess 74 and axially beyond the downstream end of support ring 72. Inner seal 48 can, in some examples, fully occupy recess 74 except for those portions that define flowpaths for spray fluid (e.g., through seal bore 110 defining first part 120). In the example shown, the downstream edge of the inner seal 48 is still within the recess 74. The downstream edge of the inner seal 48 radially overlaps with support ring 72. In this example, the inner seal 48 does not extend beyond the support ring 72 in the downstream direction DD. As such, inner seal 48 does not project axially out of the recess 74 in the downstream direction DD. In the example shown, the downstream face 108 of inner seal 48 is spaced in upstream direction UD from the downstream lip of support ring 72. In the example shown, inner seal 48 is recessed in recess 74. In the example shown, support ring 72 extends further in downstream direction DD than inner seal 48. In various other examples, the inner seal 48 can be received within the recess 74 but can extend in the downstream direction DD beyond the lip of the recess 74, such as beyond the support ring 72. In such an example, the inner seal 48 is partially radially overlapped with support ring 72 and is partially not radially overlapped with support ring 72.

Inner seal 48 facilitates secure mounting of tip assembly 25 to spray control assembly 12 and concentric alignment of flow conveying components. Support ring 72 projects axially from housing face 70. An outer diameter OD3 of support ring 72 is smaller than an inner diameter HD of the tip housing bore 102 formed through tip housing 28. Such a configuration allows support ring 72 to project into the tip housing 28 such that a portion of support ring 72 can radially overlap with a portion of tip housing 28 relative to spray axis SA. The support ring 72 projects in downstream direction DD, moving the interface between seal body 46 and inner seal 48 in downstream direction DD relative to housing face 70. Such a configuration spaces tip housing 28 from housing face 70 while structure of valve housing 59 radially overlaps with a majority of the axial length of inner seal 48 to support inner seal radially. In the example shown, the configuration facilitates structure of valve housing 59 (support ring 72 in the example shown) radially overlapping with a full axial length of inner seal 48.

Inner seal 48 projects in downstream direction DD relative to the downstream opening of valve outlet aperture 76. The inner seal 48 projects in downstream direction DD such that inner seal 48 interfaces with seal body 46 at a location spaced axially from housing face 70. With tip module 14 mounted to spray control assembly 12, the non-elastomeric inner seal 48 is mounted directly between and resists axial displacement of both seal body 46 and valve housing 59. Such a configuration braces tip housing 28 relative to valve housing 59 by the interface between seal body 46 saddle seal portion 36 and valve housing 59 and spaces tip housing 28 axially from valve housing 59. Housing gap 112 is formed between tip housing 28 and valve housing 59 such that tip housing 28 does not directly contact valve housing 59. Preventing direct contact between tip housing 28 and valve housing 59 assists in concentric stacking of flow defining components. Preventing direct contact between tip housing 28 and valve housing 59 facilitates desired alignment of barrel 38, seal body 46, inner seal 48, etc. to define tip flowpath 92 and provide desired flow characteristics to the spray fluid through tip flowpath 92 and to spray orifice 34.

Inner seal 48 is non-elastomeric. Inner seal 48 can be formed from a polymer. In some examples, inner seal 48 is formed from non-elastomeric polymer. Inner seal 48 not being elastomeric may reduce echoes of pressure waves that can affect flow of spray fluid. Such pressure waves may travel through elastomeric material and echo off of walls. Non-elastomeric polymers may resist such propagation of pressure wave echoes. Such elimination may support more even fluid flow and spray atomization, resulting in smoother coating being sprayed with fewer irregularities. Further, non-elastomeric inner seal 48 is solvent resistant, allowing for spraying and dispensing of solvent without deleterious effects on the seal between tip assembly 25 and spray control assembly 12. The solvent resistant inner seal 48 maintains the integrity of the upstream flowpath 98 by resisting the corrosive nature of solvents.

In examples including outer ring 82, the solvent-resistant inner seal 48 can isolate the elastomeric outer ring 82 from the corrosive fluid, protecting outer ring 82 from the solvent. Inner seal 48 provides a solvent-resistant bridge between the solvent-resistant valve housing 59 and the solvent-resistant seal body 46. Inner seal 48 facilitates spray gun 10 being utilized to spray solvent.

Inner seal 48 can be formed as a ring, among other options. In the example shown, inner seal 48 is formed as a cylindrical component defining a cylindrical flowpath. Inner seal 48 has outer diameter SD1, inner diameter ID2, and thickness AT. In the example shown, inner seal 48 has an outer diameter SD1 greater than a thickness AT. In the example shown, the inner diameter ID2 is a diameter of the first part 120 of upstream flowpath 98 defined by saddle seal portion 36. In the example shown, inner diameter ID2 is larger than thickness AT. In the example shown, the thickness AT is also an axial length of the first part 120 of the upstream flowpath 98. In the example shown, a largest diameter of the first part 120 defined by inner seal 48 is smaller than a diameter of the upstream-most end of seal body 48 (e.g., smaller than a diameter of seal face 58).

Seal body 46, among other components of saddle seal portion 36, can be mounted to tip housing 28 to be supported by tip housing 28. Seal body 46 is at least partially disposed in tip housing bore 102. In some examples, the seal body 46 is insertable and removable from the spray tip housing 28. At least a portion of saddle seal portion 36 is mountable and dismountable to spray control assembly 12 with other components of tip module 14. In the example shown, the seal body 46 is mountable and dismountable with tip housing 28.

The seal body 46, and outer polymer ring 82 in examples including outer ring 82, can be press fit into the spray tip housing 28, and in some examples can be removed from the spray tip housing 28, by hand force (and no threading). The saddle seal portion 36 does not rely on threading to mount to the spray tip housing 28. Saddle seal portion 36 can mount by axial movement along axis SA. The spray tip 26 can be inserted into and removed from tip housing 28 by hand force. Spray tip 26 can mount and dismount by axial movement along tip axis TA. The saddle seal portion 36 and the spray tip 26 are separately inserted into the spray tip housing 28, inserted along different axes, although they contact and seal with each other once in the spray tip housing 28. The two mount axes can be orthogonal to each other.

Outer ring 82 and saddle seal portion 36 radially overlap. In the example shown, all portions of saddle seal portion 36 radially overlapping with outer ring 82 are disposed radially inward of outer ring 82. In the example shown, outer ring 82 radially surrounds the inner seal 48. In various examples, the outer ring 82 directly radially surrounds the inner seal 48 such that an unoccupied gap is disposed directly radially between inner seal 48 and outer ring 82. In various examples, the outer ring 82 is not in contact with the inner seal 48. In the example shown, outer ring 82 radially overlaps with inner seal 48. Outer ring 82 can radially overlap with a full axial length of inner seal 48. In some examples, outer ring 82 can axially overlap with less than all of the axial length of inner seal 48.

In some examples, outer ring 82 is normally not in contact with the spray fluid. The outer ring 82 can be configured such that material is disposed directly radially between outer ring 82 and inner seal 48. In some examples, outer ring 82 and inner seal 48 are not disposed immediately radially outward of each other such that at least some other structure (e.g., structure of valve housing 59, seal body 46, or another component) is disposed directly radially between outer ring 82 and inner seal 48. In the example shown, support ring 72 is disposed directly radially between outer ring 82 and inner seal 48. In the example shown, a radial line extending outward from axis SA at least one location along spray axis SA within first part 120 extends through inner seal 48, then structure of valve housing 59 (e.g., support ring 72), then outer ring 82.

The outer ring 82 may serve as a backup seal to the inner seal 48, such as if the inner seal 48 is compromised or lost during maintenance. Outer ring 82 can form an annular face seal with valve housing 59 in the upstream direction UD. Outer ring 82 can be formed from a polymer. In some examples, the outer ring 82 may be elastomeric (e.g., rubber, synthetic elastomer, etc.) while the inner seal 48 is not elastomeric. In some examples, a radial thickness W1 of outer ring 82 is less than a radial wall thickness W2 of the inner seal 48, such as a thickness taken from a wall of inner seal 48 defining seal bore 110 radially outward to the outer radial edge of inner seal 48. In the example shown, an axial length of the outer ring 82 is greater than an axial length AT of the inner seal 48.

In the example shown, seal body 46 is in annular contact with each of the outer ring 82 and the inner seal 48. In the example shown, the annular contact between outer ring 82 and seal body 46 is a radial contact (with body projection 54) and axial contact (with shoulder 52) while the annular contact between inner seal 48 and seal body 46 is axial contact.

In various examples, outer ring 82 is retained on the seal body 46. In the example shown, a portion of the axial length of outer ring 82 is directly supported by seal body 46. A portion of the length of outer ring 82 is not radially supported inward towards axis SA, in the example shown. As shown, void 114 is formed between outer ring 82, saddle seal portion 36, and valve housing 59. Void 114 extends annularly about axis SA. Void 114 is open but is not fluidly connected to the tip flowpath 92 that routes spray fluid. In the example shown, outer ring 82 can be disposed such that a portion of void 114 is disposed directly radially between outer ring 82 and portions of valve housing 59. In the example shown, outer ring 82 extends axially such that outer ring 82 radially overlaps with seal body 46 and radially overlaps with valve housing 59. Outer ring 82 radially overlaps with both metallic portions of saddle seal portion 36 (e.g., seal body 46) and non-elastomeric polymer portions of saddle seal portion 36 (e.g., inner seal 48).

Tip module 14 is removable from valve housing 59 to position the inner seal 48 to engage and annularly seal with the valve housing 59. Inner seal 48 is disposed upstream of seal body 46. Inner seal 48 is configured to interface with seal body 46 and valve housing 59. Inner seal 48 forms a non-elastomeric potion that bridges between valve housing 59 and seal body 46. In the example shown, inner seal 48 forms a polymeric portion that bridges between valve housing 59 and seal body 46. Inner seal 48 can be supported by seal body 46 or can be supported by spray control assembly 12. In the example shown, inner seal 48 is mounted to valve housing 59 such that inner seal 48 remains mounted to spray control assembly 12 during mounting and dismounting of tip module 14. As such, seal body 46 moves into and out of contact with inner seal 48 during mounting and dismounting of tip module 14, respectively.

Inner seal 48 defines a portion of the flowpath for spray fluid along spray axis SA. Inner seal 48 includes a portion of the flowpath through a central bore of the saddle seal portion 36. In the example shown, inner seal 48 defines a portion of the upstream flowpath 98. Such portion can be considered to form a first part 120 of the upstream flowpath 98, the first part 120 being defined by inlet orifice 116 and outlet orifice 118 of the inner seal 48. The first part 120 extends axially between an upstream side (e.g., at least partially formed by upstream face 106) of inner seal 48 and a downstream side (e.g., at least partially formed by downstream face 108) of inner seal 48. The first part 120 receives spray fluid from valve 78 through the inlet orifice 116 and outputs spray fluid to seal body 46 through the outlet orifice 118. The first part 120 has the diameter ID2 and axial length AT in the example shown.

In the example shown, the first part 120 is radially overlapped by inner seal 48 and by material of spray control assembly 12. In the example shown, the first part 120 is disposed radially within material of the valve housing 59 such that first part 120 is radially overlapped by material forming valve housing 59. In the example shown, the first part 120 is radially overlapped by support ring 72 that projects axially from housing face 70.

Seal body 46 defines a portion of the flowpath through the central bore of the saddle seal portion 36. Such portion can be considered to form a second part 122 of the upstream flowpath 98. The second part 122 extends between body inlet 124 and body outlet 126 orifices of the seal body 46. Second part 122 extends between an upstream aperture forming body inlet 124 of body bore 56 through seal body 46 and a downstream aperture forming body outlet 126 of the body bore 56 through seal body 46. The second part 122 extends between the seal face 58 of seal body 46 oriented in upstream direction UD and the downstream face of seal body 46 oriented in downstream direction DD. The downstream face is formed by saddle face 50 in the example shown. In the example shown, a portion of the length of second part 122 is not radially overlapped by inner seal 48. In the example shown, no portion of second part 122 is radially overlapped by inner seal 48. Second part 122 has diameter ID3 and axial length BT, which is an axial length of body bore 56.

The second part 122 is axially aligned with first part 120 to receive spray fluid into second part 122 from first part 120. The first part 120 and second part 122 can be cylindrical flowpaths. The first part 120 and the second part 122 can be coaxially disposed on axis SA. The first part 120 can have a consistent inner diameter ID2 along a length AT of first part 120. The first part 120 can have a consistent inner diameter ID2 along an axial length AT of inner seal 48. In the example shown, the diameter of the first part 120 is the same as the inner diameter of the inner seal 48. The second part 122 can have a consistent inner diameter ID3 along a length BT of second part 122.

The respective diameters ID2, ID3 of the first part 120 and the second part 122 can be the same or can be different. In some examples, a largest inner diameter of the upstream flowpath 98 is no greater than two times a smallest inner diameter of the upstream flowpath 98. In some examples, a largest inner diameter of the first part 120 of the upstream flowpath 98 is smaller than a largest inner diameter of the tunnel 80. The upstream flowpath 98 does not include a radial expansion pocket, whereby the radial expansion pocket is directly radially outward from the axis SA and formed such that structure of the seal body 46 exists directly radially between the axis SA and the radial expansion pocket.

The respective inner diameters may be no more different than 115% relative to each other. The respective inner diameters may be no more different than 150% relative to each other. The respective inner diameters may be no more different than 200% relative to each other. In some examples, one of ID2 and ID3 is larger than the other of ID2 and ID2. In some examples, ID2 and ID3 are the same as each other. In the example shown, an axial length AT of first part 120 can be less than an axial length BT of second part 122. In some examples, the axial length AT of first part 120 is less than half of an axial length BT of second part 122. In some examples, the axial length AT of first part 120 is less than one third of an axial length BT of second part 122.

In some examples, the respective diameters ID2, ID3 of first part 120 and second part 122 can be variable along the length of first part 120 and/or second part 122. In some examples, an average inner diameter of the first part 120 and an average inner diameter of the second part 122 may be no more different than 115% relative to each other. The average inner diameter of the first part 120 and the average inner diameter of the second part 122 may be no more different than 150% relative to each other. The average inner diameter of the first part 120 and the average inner diameter of the second part 122 may be no more different than 200% relative to each other.

In some examples, a minimum (i.e. smallest) inner diameter of the first part 120 and a minimum inner diameter of the second part 122 may be no more different than 115% relative to each other. The minimum inner diameter of the first part 120 and the minimum inner diameter of the second part 122 may be no more different than 150% relative to each other. The minimum inner diameter of the first part 120 and the minimum inner diameter of the second part 122 may be no more different than 200% relative to each other.

In some examples, a minimum inner diameter of the first part 120 and a maximum (i.e., largest) inner diameter of the second part 122 may be no more different than 115% relative to each other. The minimum inner diameter of the first part 120 and the maximum inner diameter of the second part 122 may be no more different than 150% relative to each other. The minimum inner diameter of the first part 120 and the maximum inner diameter of the second part 122 may be no more different than 200% relative to each other.

In some examples, a maximum inner diameter of the first part 120 and a minimum inner diameter of the second part 122 may be no more different than 115% relative to each other. The maximum inner diameter of the first part 120 and the minimum inner diameter of the second part 122 may be no more different than 150% relative to each other. The maximum inner diameter of the first part 120 and the minimum inner diameter of the second part 122 may be no more different than 200% relative to each other.

In some examples, the inner diameter ID2 of the first part 120 can be smaller than the inner diameter TD of the tunnel 80. The inner diameter ID2 of the first part 120 can be the same as the inner diameter Do of the valve outlet aperture 76. The inner diameter ID2 of the first part 120 can be within 115% of the inner diameter Do of the valve outlet aperture 76. The inner diameter ID2 of the first part 120 can be within the 150% of the inner diameter Do of the valve outlet aperture 76. The inner diameter ID2 of the first part 120 can be within 200% of the inner diameter Do of the valve outlet aperture 76.

In the example shown, the tip flowpath 92 downstream of valve 78 reduces through saddle seal portion 36. The diameter ID2 of first part 120 can be the same size as or vary in size from the diameter Do of the valve outlet aperture 76. The diameter ID2 of first part 120 can be smaller or larger than diameter Do of valve outlet aperture 76 in various examples. In some examples, the diameter of the first part 120 and the diameter of the valve outlet aperture 76 are no more different than 115% relative to each other. In some examples, the diameter of the first part 120 and the diameter of the valve outlet aperture 76 may be no more different than 150% relative to each other. In some examples, the diameter of the first part 120 and the diameter of the valve outlet aperture 76 may be no more different than 200% relative to each other.

In some examples, the largest diameter of the upstream flowpath 98 and the largest diameter of the valve outlet aperture 76 are no more different than 115% relative to each other. In some examples, the largest diameter of the upstream flowpath 98 and the largest diameter of the valve outlet aperture 76 may be no more different than 150% relative to each other. In some examples, the largest diameter of the upstream flowpath 98 and the largest diameter of the valve outlet aperture 76 may be no more different than 200% relative to each other.

In some examples, the largest diameter of the upstream flowpath 98 and the smallest diameter of the upstream flowpath 98 are no more different than 115% relative to each other. In some examples, the largest diameter of the upstream flowpath 98 and the smallest diameter of the upstream flowpath 98 may be no more different than 150% relative to each other. In some examples, the largest diameter of the upstream flowpath 98 and the smallest diameter of the upstream flowpath 98 may be no more different than 200% relative to each other.

In the example shown, the diameter ID3 of second part 122 is smaller than the diameter ID2 of first part 120. As such, first part 120 forms a largest diameter portion of the upstream flowpath 98 in the example shown. It is understood, however, that the diameter ID3 of the second part 122 can be the same as or larger than the diameter ID2 of the first part 120 in various other examples. In some examples, portions of first part 120 have a smaller diameter than portions of second part 122 while other portions of first part 120 have a larger diameter than portions of second part 122. In some examples, portions of first part 120 have a larger diameter than portions of second part 122 while other portions of first part 120 have a smaller diameter than portions of second part 122. In some examples, portions of first part 120 have a larger or smaller diameter than portions of second part 122 while other portions of first part 120 have the same diameter as portions of second part 122. The upstream flowpath 98 does not include jet outs or other sudden radial enlargements.

In the example shown, the largest diameter of upstream flowpath 98 is smaller than the diameter Db of the ball 66. Such a configuration may reduce pressure echoes and provide for more consistent atomization and spraying.

In the example shown, the inner seal 48 has a consistent inner diameter ID2 along its length AT. Such length AT can be the length of the first part 120 of the upstream flowpath 98.

In the example shown, the wall of the recess 74 (in this case formed by the support ring 72) radially supports the inner seal 48. The wall of the recess 74 circumferentially contacts and supports the inner seal 48 to prevent or limit radial expansion due to fluid pressure. Such circumferential support helps keep the inner seal 48 in place to support sealing and prevent the generation of an expansion chamber.

Inner seal 48 is configured to provide a sealing component that forms a seal between portions of spray gun 10 that dismount relative to gun housing 16 and portions of spray gun 10 that remain mounted on gun housing 16 with tip module 14 dismounted. Inner seal 48 at least partially defines the flowpath of the spray fluid through tip assembly 25. Inner seal 48 is disposed at an upstream end of the tip flowpath 92. In the example shown, inner seal 48 at least partially defines the tip flowpath 92. In the example shown, inner seal 48 is at least partially exposed to the spray fluid flowing through tip flowpath 92. In the example shown, inner seal 48 defines first part 120 of upstream flowpath 98 of tip flowpath 92.

Inner seal 48 engages with seal body 46 and valve housing 59 to form a gap bridge therebetween. The gap bridge spans between the valve housing 59 and seal body 46 and conveys spray fluid therebetween under pressure. The gap bridge radially retains the spray fluid and prevents jet outs of the spray fluid. The gap bridge eliminates expansion pockets that extend radially outward relative to second part 122 through seal body 46 and which can radially overlap with seal body 46 at locations radially outward of seal body 46.

Inner seal 48 interfaces with an axially oriented seal face 58 of seal body 46 at an intersection within the upstream flowpath 98. The interface between inner seal 48 and seal body 46 is disposed at an intersection between first part 120 and second part 122 of upstream flowpath 98. In the example shown, the axial interface is formed between downstream face 108 of inner seal 48 and body projection 54, though it is understood that other configurations are possible. In the example shown, the axial interface is formed between inner seal 48 and projection 84b.

Projection 84b has a diameter OD4. The OD4 diameter of projection 84b is smaller than an inner diameter of recess 74. As such, seal body 46 can extend axially into recess 74 without contacting structure defining recess 74, such as portions of valve housing 59. Such a configuration can allow body projection 54 to extend recess 74 to radially overlap with support ring 72.

In the example shown, the diameter OD4 of projection 84b is smaller than the outer diameter SD1 of the inner seal 48. As such, at least a portion of the downstream face 108 is not axially overlapped by the seal face 58. It is understood, however, that not all examples are so limited. The smaller diameter OD4 relative to diameter SD1 provides a seal with a full area of the seal face 58, providing good sealing and which can assist in concentric alignment of second part 122 and first part 120 on axis SA.

The reduced diameter OD4 of projection 84b relative to diameter SD1 of inner seal 48 can assist in generating a mechanical biasing force on seal body 46 in downstream direction DD. Seal body 46 can be biased into contact with barrel 38 to seal against barrel 38. In some examples, inner seal 48 biases seal body 46 in downstream direction DD along axis SA. Inner seal 48 is non-elastomeric and resists the opposing forces exerted by valve housing 59 and seal body 46, biasing seal body 46 in downstream direction DD.

In the example shown, tip assembly 25 is mounted to spray control assembly 12 by a threaded interface between tip mount 30 and housing mount 24. Threading tip mount 30 to housing mount 24 displaces tip assembly 25 in upstream direction UD relative to valve housing 59, pressing seal body 46 into inner seal 48. Inner seal 48 is non-elastomeric and braces against valve housing 59 to bias seal body 46 in downstream direction DD to contact barrel 38. The torque exerted on the threaded connection can directly affect the axial biasing force exerted on seal body 46 such that greater torque can bias seal body 46 further in downstream direction DD. Such a configuration can maintain desired sealing between seal body 46 and barrel 38, even when spraying at relatively low pressures (e.g., less than about 200 psi) and with thin fluids (e.g., water). Mechanically biasing seal body 46 into contact with barrel 38 prevents leakage pathways from forming between seal body 46 and barrel 38.

Seal body 46 can directly contact barrel 38 while not directly contacting the valve housing 59. Inner seal 48 is disposed directly axially between seal body 46 and valve housing 59. The inner seal 48 bridges between seal body 46 and valve housing 59 such that seal body 46 and valve housing 59 are not in direct contact. In the example shown, inner seal 48 can be considered to be sandwiched between seal body 46 and valve housing 59.

Inner seal 48 provides a spacer between seal body 46 and valve housing 59 to prevent contact therebetween. The spacer formed by inner seal 48 is non-elastomeric such that inner seal 48 is configured to not crush between seal body 46 and valve housing 59. The inner seal 48 may be compressed less than 5%, less than 3%, less than 1%, less than 0.5%, or less of its axial length AT when sandwiched between seal body 46 and valve housing 59 such that inner seal 48 exerts axial force on both seal body 46 and valve housing 59.

Inner seal 48 is disposed such that the downstream face 108 of inner seal 48 is fully axially overlapped by seal body 46. In the example shown, a radially inner portion of the downstream face 108 of inner seal 48 axially overlaps with the exterior of projection 84b while a radially outer portion of the downstream face 108 axially overlaps with the exterior of projection 84a. The portion of downstream face 108 axially overlapping with projection 84b is in contact with projection 84b. The portion of downstream face 108 axially overlapping with portions of seal body 46 radially outward of seal face 58 is not in contact with seal body 46 in the example shown. The portion of downstream face 108 disposed radially outward from seal face 58 such that that portion of downstream face 108 does not axially overlap with projection 84b also does not contact seal body 46 in the example shown, though it is understood that not all examples are so limited.

A surface area of inner seal 48 axially overlapping with seal body 46 is greater than a surface area of inner seal 48 radially overlapping with seal body 46 in the example shown. The portion of downstream face 108 disposed radially outward from projection 84b to not axially overlap with projection 84b does not extend to radially overlap with seal body 46, though it is understood that not all examples are so limited. In some examples, inner seal 48 can wrap over portions of seal body 46 to radially overlap with portions of seal body 46 contacting inner seal 48. In some such examples, inner seal 48 is in contact with seal face 58 and portions of seal body 46 radially outward of seal face 58. Such configurations are discussed in more detail below.

During operation, spray fluid flows to valve chamber 128 within valve housing. Needle 60 is displaced in upstream direction UD (e.g., mechanically, electrically, fluidically by pressure in valve chamber 128, etc.). Ball 66 disengages from seat 64, opening valve 78 and allowing spray fluid to flow downstream from valve 78.

The spray fluid flows through valve outlet aperture 76 and enters into tip flowpath 92. The spray fluid enters tip flowpath 92 through the inlet orifice 116 on the upstream side of inner seal 48. The inner seal 48 is the first portion of saddle seal portion 36 to contact spray fluid as the spray fluid flows downstream for emission from spray tip 26. Unlike the positioning of outer ring 82, inner seal 48 is disposed such that spray fluid does not have to travel radially outward for a majority of the diameter of the upstream facing side of seal body 46 before contacting inner seal 48. Instead, inner seal 48 bridges between valve housing 59 and seal body 46 and eliminates jet outs and expansion chambers or pockets between spray control assembly 12 and seal body 46.

The spray fluid flows through the non-elastomeric bridge pathway between valve outlet orifice 118 and seal body 46. The non-elastomeric material of inner seal 48 defines first part 120 such that the fluid contacts the non-elastomeric material as the fluid flows through first part 120. Inner seal 48 bridges between seal body 46 and valve housing 59 such that upstream flowpath 98 does not include any portions directly radially outward of material of seal body 46. No portion of upstream flowpath 98 radially inward of the inner wall of inner seal 48, such inner wall defining seal bore 110, is disposed radially outward of and radially overlaps with material of the seal body 46. In the example shown, no portion of upstream flowpath 98 is disposed such that a line extending radially outward from axis SA extends through seal body 46 and then at a radially outward location through a portion of upstream flowpath 98 in which spray fluid is normally disposed during spray operation. In the example shown, a largest diameter of upstream flowpath 98 is smaller than the diameter Db of ball 66.

The spray fluid exits first part 120 through the outlet orifice 118 of inner seal 48 and enters into second part 122 of upstream flowpath 98 defined by seal body 46. The spray fluid flows through body bore 56 in seal body 46 and then downstream for emission through spray orifice 34, assuming spray tip 26 is in the spray position. In the example shown, the spray fluid flows through retainer 44, pre-orifice piece 42, and tip piece 40 for emission through spray orifice 34. Spring 62 displaces needle 60 in downstream direction DD to cause ball 66 to engage with seat 64 to stop spraying.

Saddle seal portion 36 provides significant advantages. Inner seal 48 defines first part 120 of upstream flowpath 98. The spray fluid flows through inner seal 48 prior to entering into seal body 46. Inner seal 48 defines first part 120 such that first part 120 is defined by non-elastomeric material, such as non-elastomeric polymer. Inner seal 48 can be non-elastomeric such that inner seal 48 can resist pressure echoes and fluctuations, providing for consistent and even flow and atomization. Inner seal 48 being non-elastomeric further facilitates spraying of solvents as the non-elastomeric inner seal 48 is solvent resistant.

Inner seal 48 engages with the seal face 58 of seal body 46 and with housing face 70 of valve housing 59. The torqued interface between tip mount 30 and housing mount 24 drives seal body 46 in upstream direction UD and into inner seal 48 exerting an axial force on inner seal 48 in upstream direction UD. Valve housing 59 resists inner seal 48, exerting a force in downstream direction DD on inner seal 48, causing the non-elastomeric inner seal 48 to bias seal body 46 in downstream direction DD. Seal body 46 is biased along axis SA and towards barrel bore 100, positioning seal body 46 to directly engage and seal against barrel 38. Inner seal 48 mechanically biases seal body 46 into engagement with barrel 38, reducing reliance on hydraulic pressure to engage seal body 46 with barrel 38, and thereby preventing leakage and providing for more consistent spraying and atomization. Such a configuration can be particularly useful when spraying at relatively low pressures (e.g., below about 200 psi) or with relatively thin fluids (e.g., water-based fluids, solvents, etc.).

Inner seal 48 is radially supported by support ring 72. Support ring 72 can inhibit radial deformation of inner seal 48. Support ring 72 can be formed from a metal while inner seal 48 can be formed from polymer, such as non-elastomeric polymer. Seal body 46 can be formed from metal. The full axial length of upstream flowpath 98 is radially defined by non-elastomeric material in the example shown. In some examples, no portion of upstream flowpath 98 is defined by elastomer. Such a configuration further inhibits pressure echoes and fluctuations providing for more consistent spraying and atomization.

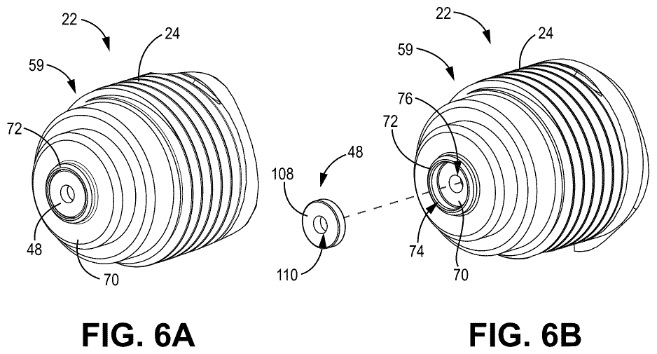

FIG. 6A is an enlarged isometric view showing inner seal 48 mounted to a downstream end of spray control assembly 12. FIG. 6B is a partially exploded isometric view showing inner seal 48 exploded away from the downstream end of spray control assembly 12. FIGS. 6A and 6B are discussed together.

The downstream end of spray control assembly 12 is shown in FIGS. 6A and 6B. Housing mount 24 for connecting with tip assembly 25 is shown. In the example shown, housing mount 24 is formed as exterior threading. In the example shown, housing mount 24 is formed by a portion of valve housing 59. It is understood, however, that not all examples are so limited. For example, gun housing 16 can extend over portions of valve housing 59 and can include threading for mating with the tip mount 30 to mount the tip module 14. In additional or alternative examples, housing mount 24 can be formed as a connection other than a threaded interface, such as a bayonet connection among other options.

As shown, the downstream end of the valve housing 59 includes recess 74. Set within the recess 74 is the inner seal 48. When dismounting the spray tip housing 28 and the saddle seal portion 36 along with the spray tip housing 28, the inner seal 48 can be retained within the recess 74 of the valve assembly 22. As such, inner seal 48 can remain mounted to spray control assembly 12 while other portions of tip assembly 25 are dismounted from spray control assembly 12. Inner seal 48 can be mounted within recess 74 to be supported by valve housing 59 prior to mounting of other components of tip assembly 25 to spray control assembly 12. The downstream face seal between inner seal 48 and seal body 46 can thus be formed during mounting of tip module 14 and broken during dismounting of tip module 14.

Inner seal 48 can be mounted to valve body 59 to be supported by valve body 59. The inner seal 48 may be press-fit into recess 74, among other mounting options. FIG. 6B shows the removal of the inner seal 48 from within the recess 74. Such dismounting of the inner seal 48 exposes the valve outlet aperture 76 through which spray fluid exits from within an interior valve chamber 128 within valve housing 59. The inner seal 48 can be mounted to valve housing 59 such that inner seal 48 may only be removed with deliberate removal force, such that gravity or normal bumps of jostling would not dislodge the inner seal 48 from the recess 74. For example, inner seal 48 can be press fit into recess 74. The inner seal 48 may be picked out from recess 74 with a tool, such as a pick.

Inner seal 48 mounting to valve housing 59 to be supported by valve housing 59 provides significant advantages. Inner seal 48 is circumferentially surrounded by the material of valve housing 59 that forms support ring 72. Support ring 72 inhibits radial deformation of inner seal 48 due to pressure within first part 120 of upstream flowpath 98. Support ring 72 concentrically aligns inner seal 48 on axis SA, providing for smooth fluid flow into seal body 46 from valve outlet aperture 76. Maintaining concentricity of inner seal 48 on spray axis SA facilitates consistent spray fluid flow into and through tip flowpath 92, resulting in consistent spray output and atomization.

Inner seal 48 remains mounted to spray control assembly 12 when tip module 14 is dismounted. Such a configuration allows for a single inner seal 48 to be utilized while the user can swap out different tip modules 14, such as for spraying of different fluids, spraying different patterns, etc. Such a configuration reduces part count, reduces cost, and reduces complexity of operation.

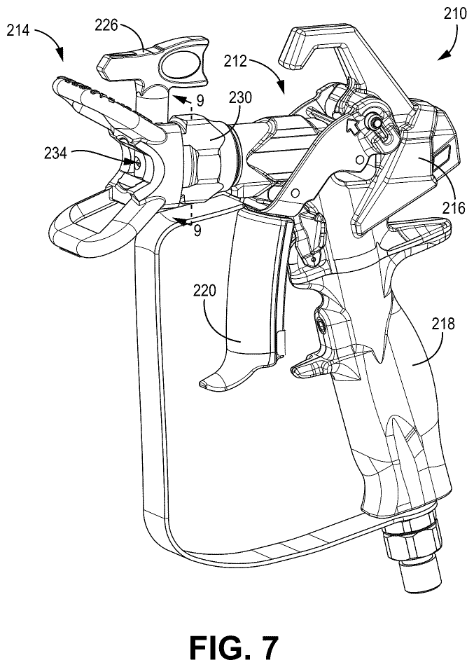

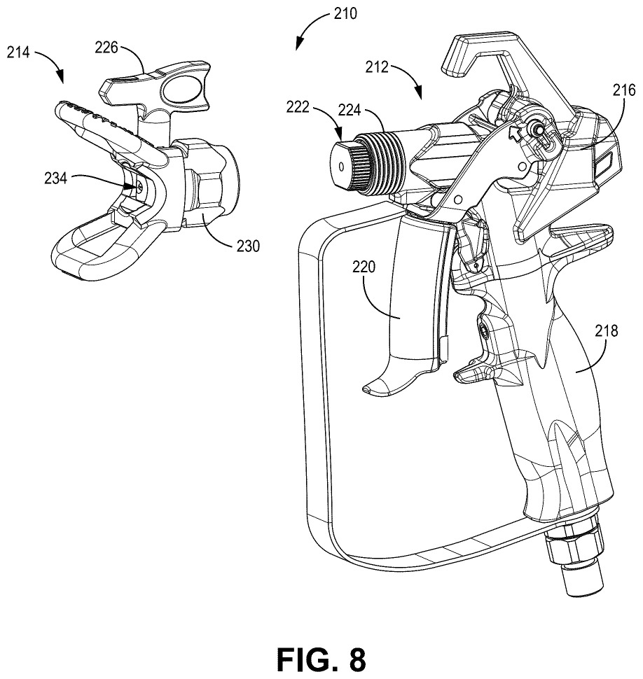

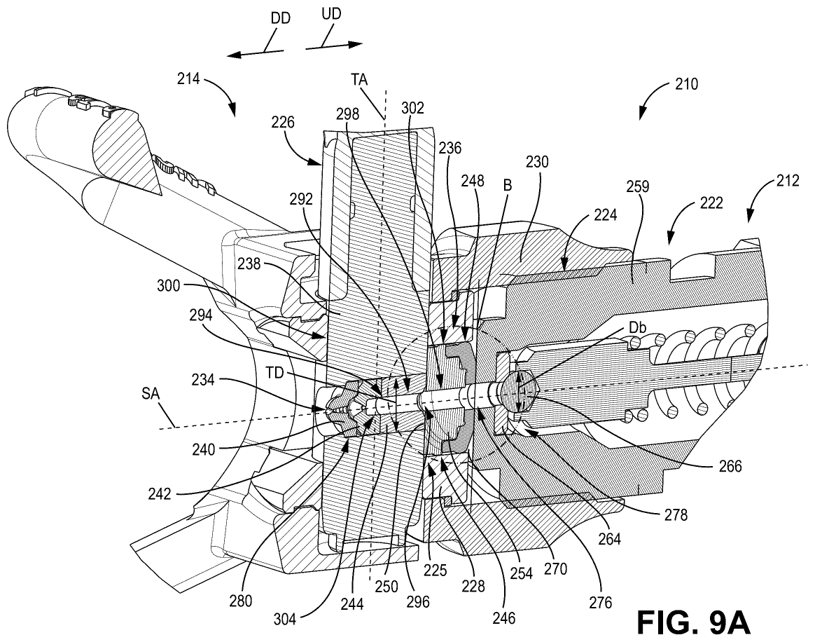

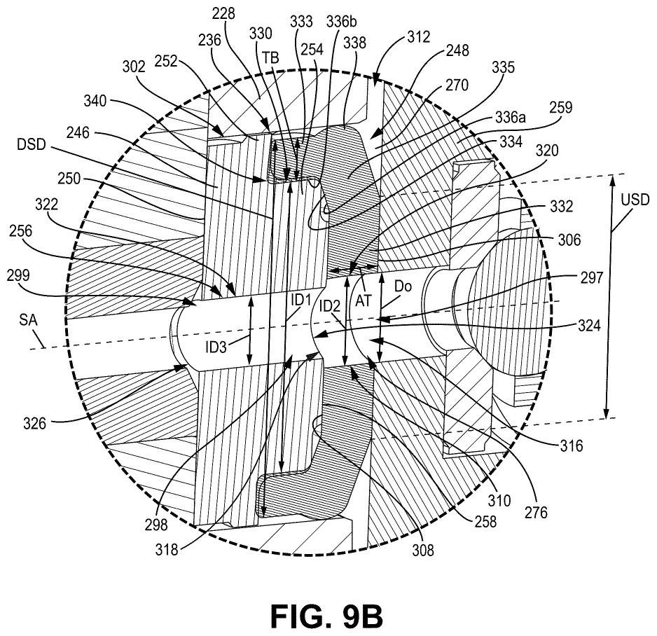

FIG. 7 is an isometric view of spray gun 210. FIG. 8 is an isometric view of spray gun 210 showing tip module 214 exploded away from spray control assembly 212. FIG. 9A is a cross-sectional view taken along line 9-9 showing tip module 214 mounted to spray control assembly 212. FIG. 9B is an enlarged view of detail B in FIG. 9A. FIGS. 7-9B are discussed together. Spray gun 210′is substantively similar to spray gun 10 (best seen in FIGS. 1 and 2) except that housing face 270 of spray control assembly 212 does not include a recess (e.g., recess 74) to support inner seal 248. Tip assembly 225 is substantively similar to tip assembly 25 (best seen in FIGS. 3A-5A) except that inner ring 332 is fully supported by seal body 246 rather than partially supported on seal body 246 and partially supported on spray control assembly 212.

Components of spray gun 210 that are similar to components of spray gun 10 have the same reference numbers except increased by “200” (e.g., spray gun 10 and spray gun 210). Aspects of the common reference numbers but increased by the indicated amount can be the same as between examples unless clearly shown or described to be different. Aspects from one example can be implemented in the other examples such that aspects from these two or more different examples can be readily swapped in any combination. As such, common aspects may not be repeated as between the multiple examples for the sake of brevity and may not be discussed or labeled in later examples for the sake of brevity.

In the example shown, valve assembly 222 includes a flush downstream housing face 270. No recess is formed in housing face 270 or on valve housing 259. The valve outlet aperture 276 can clearly be seen after removal of the spray tip housing 228. Housing mount 224 is formed by gun housing 216 in the example shown. The housing mount 224 is formed as threading configured to mate with the threaded tip mount 230 of tip assembly 225. In the example shown, housing mount 224 is formed as exterior threading on gun housing 216. It is understood, however, that spray control assembly 212 can be configured similar to spray control assembly 12 such that housing mount 224 is formed on valve housing 259. In the example shown, valve housing 259 can be mounted to and dismounted from gun housing 216, such as by interfaced threading between an exterior of valve housing 259 and interior threading within a bore of gun housing 216. In some examples, tip module 214 can retain valve housing 259 on gun housing 216 when tip module 214 is mounted to spray control assembly 212. Handle 218 and gun housing 216 can be considered to form a gun body. The gun body can be monolithic. Trigger 220 is configured to be depressed to open valve 278. Spray tip 226 is configured to mount within barrel bore 300. Spray tip 226 is rotatable on tip axis TA while within barrel bore 300 and engaged with seal body 246 between the spray and de-clog states.

Saddle seal portion 236 is configured to receive spray fluid into tip flowpath 292 through tip assembly 225. In the example shown, the main tip pathway 292 including the upstream flowpath 298 and the pre-wall path portion 304 does not include an expansion pocket, the expansion pocket defined as any radial chamber having an average inner diameter greater than two times of an average inner diameter of a total remainder of the tip pathway 292 and having an axial length less than one third of an axial length of the tip pathway 292.

Saddle seal portion 236 receives spray fluid output from valve 278 and fluidly connects valve 278 and the downstream flowpath 294 through spray tip 226. Saddle seal portion 236 defines upstream flowpath 298. Upstream flowpath 298 extends between portion inlet 297 and portion outlet 299. Saddle seal portion 236 receives spray fluid through portion inlet 297 and outputs the spray fluid through portion outlet 299. Portion inlet 297 is defined by inner seal 248 and portion outlet 299 is defined by seal body 246. Portion inlet 297 is formed though an upstream face 306 of inner seal 248. Portion outlet 299 is formed through saddle face 250. In some examples, the upstream flowpath 298 is defined only by the inner seal 248 and the seal body 246. Upstream flowpath 298 extends along axis SA. Axis SA extends through upstream flowpath 298. Upstream flowpath 298 can be disposed coaxially with valve outlet aperture 276.

In the example shown, inner seal 248 does not include multiple discrete rings (e.g., inner seal 48 and outer ring 82). Instead, inner seal 248 is formed as a single component. Inner seal 248 can be configured as a monolithic body. Inner seal 248 is of a different shape as previously shown for inner seal 48. Inner seal 248 can be formed from polymer, such as a non-elastomeric polymer. At least the portion of inner seal 248 bridging axially between valve housing 259 and seal body 246 and defining the first part 320 is non-elastomeric. In some examples, inner seal 248 is fully formed form non-elastomeric material, such as non-elastomeric polymer. Inner seal 248 defines at least a part of an upstream end of saddle seal portion 236.

Inner seal 48 is tubular whereas in the example shown in FIGS. 9A and 9B the inner seal 248 is cup-like (albeit with a central aperture). Inner seal 248 is concave in the downstream direction DD and convex in the upstream direction UD. The inner seal 248 wraps partially around seal body 246 such that portions of seal body 246 are disposed within inner seal 248 to radially overlap with inner seal 248. In the example shown, inner seal 248 wraps fully annularly about portions of seal body 246 to extend fully annularly about axis SA.

The seal bore 310 extends fully axially through inner ring 332 along axis SA and defines first part 320. The seal bore 310 extends fully axially through inner ring 332 such that seal bore 310 is open in upstream direction UD and in downstream direction DD. The outlet orifice 318 through inner seal 248 forms a downstream opening through which spray fluid exits seal bore 310. In the example shown, the outlet orifice 318 is spaced in upstream direction UD from the downstream end of inner seal 248. The inlet orifice 316 through inner seal 248 forms an upstream opening through which spray fluid enters into seal bore 310. The inlet orifice 316 is disposed at an upstream-most end of inner seal 248, in the example shown.

In the example shown, the interior of inner seal 248 widens to receive seal body 246 into the concave seal chamber 330 defined by inner seal 248. Seal opening 340 is formed at a downstream end of inner seal 248. The outlet orifice 318 is open into the concave seal chamber 330 in the example shown. In the example shown, the diameter of the seal opening 340 is at least two times larger than a diameter of the seal bore 310. In the example shown, the diameter of the seal opening 340 is at least two times larger than a largest diameter of the upstream flowpath 298.

Seal body 246 extends into and is at least partially disposed within seal chamber 330. The seal body 246 extends into seal chamber 330 through seal opening 340 in the example shown. Seal body 246 is sized such that the seal body 246 cannot extend fully axially through the inner seal 248. In the example shown, the seal body 246 is radially larger than the inlet orifice 516 such that seal body 246 cannot pass through inlet orifice 516. Seal body 246 extends into seal chamber 330 to occupy volume within seal chamber 330. In the example shown, chamber wall 334 that defines seal chamber 330 is in contact with seal body 246. Chamber wall 334 can contact seal body across a full length of the chamber wall 334, such as from a portion of chamber wall 334 extending to seal bore 310 to a portion of chamber wall 334 at seal opening 340.

Inner seal 248 is configured such that a body of inner seal 248 contacts seal body 246 to form an axial face seal therebetween (e.g., annularly surrounding outlet orifice 318 at the interface between seal body 246 and inner seal 248). Inner seal 248 further contacts seal body 246 to form a radial face seal therebetween (e.g., annularly surrounding body projection 254 between an outer surface of body projection 254 and an inner radial face of inner seal 248). In the example shown, body projection 254 extends into seal chamber 330. In the example shown, a portion of seal body 246 extends in downstream direction DD outside of seal chamber 330 such that seal body 246 is partially disposed inside of seal chamber 330 and partially disposed outside of seal chamber 330.

Body bore 256 is formed through seal body 246. Body bore 256 extends fully axially through seal body 246 in the example shown. Body bore 256 defines second part 322 of upstream flowpath 298. Body bore 256 is disposed coaxially with seal bore 310 on axis A. Body bore 256 extends along axis A between body inlet 324 formed by an upstream orifice through seal face 258 of seal body 246 at which body bore 256 receives spray fluid from inner seal 248 and body outlet 326 formed by a downstream orifice through saddle face 250 through which body bore 256 outputs spray fluid to the spray components (e.g., tip piece 240, pre-orifice piece 242, and retainer 244) of the spray tip 226.

Seal bore 310 has a diameter ID2 and body bore 256 has a diameter ID3. The diameter ID2 is larger than the diameter ID3 in the example shown. It is understood, however, that not all examples are so limited. For example, the diameter ID2 can be smaller than diameter ID3 or ID2 can be the same as ID3. In some examples, seal bore 310 is cylindrical and/or body bore 256 is cylindrical. The respective widths of the seal bore 310 and body bore 256 can be the same or can be different. The respective diameters of the seal bore 310 and body bore 256 may be no more different than 115% relative to each other. The respective diameters of the seal bore 310 and body bore 256 may be no more different than 150% relative to each other. The respective diameters of the seal bore 310 and body bore 256 may be no more different than 200% relative to each other.

In the example shown, valve outlet orifice 318 has a diameter Do. The outlet orifice 318 can be cylindrical. The diameter Do can be the same as the diameter ID2 of seal bore 310. In such an example, the flowpath of the spray fluid flowpath does not expand radially directly downstream of valve housing 259 and between valve housing 259 and seal body 246. In some examples, Do can be larger than ID2 or can be smaller than ID2. In the example shown, a largest diameter of upstream flowpath 298 is smaller than the diameter Db of ball 266 that engages with seat 264 to close valve 278. In the example shown, a largest diameter of the upstream flowpath 298 is smaller than a diameter through tunnel 280.

In some examples, the diameter of the first part 320 and the diameter of the valve outlet aperture 276 are no more different than 115% relative to each other. In some examples, the diameter of the first part 320 and the diameter of the valve outlet aperture 276 may be no more different than 150% relative to each other. In some examples, the diameter of the first part 320 and the diameter of the valve outlet aperture 276 may be no more different than 200% relative to each other.

In some examples, the largest diameter of the upstream flowpath 298 and the largest diameter of the valve outlet aperture 276 are no more different than 115% relative to each other. In some examples, the largest diameter of the upstream flowpath 298 and the largest diameter of the valve outlet aperture 276 may be no more different than 150% relative to each other. In some examples, the largest diameter of the upstream flowpath 298 and the largest diameter of the valve outlet aperture 276 may be no more different than 200% relative to each other.

In some examples, the largest diameter of the upstream flowpath 298 and the smallest diameter of the upstream flowpath 298 are no more different than 115% relative to each other. In some examples, the largest diameter of the upstream flowpath 298 and the smallest diameter of the upstream flowpath 298 may be no more different than 150% relative to each other. In some examples, the largest diameter of the upstream flowpath 298 and the smallest diameter of the upstream flowpath 298 may be no more different than 200% relative to each other.

In the example shown, the flowpath of the spray fluid through valve outlet orifice 318 and upstream flowpath 298 has a constant diameter (e.g., through valve outlet orifice 318 and first part 320) and then a reduced diameter (e.g., through second part 322). In the example shown, the flowpath does not increase in diameter in the downstream direction DD from the downstream end of valve outlet orifice 318 to the body inlet 324 of body bore 256.

Inner seal 248 includes annular band 333. The annular band 333 can mount around the body projection 254 of the seal body 246. In the example shown, the annular band 333 is an axially extending portion of inner seal 248 that engages radially with seal body 246. Annular band 333 radially surrounds portions of seal body 246. Annular band 333 is disposed radially outward of and radially overlaps with portions of seal body 246. In the example shown, annular band 333 axially overlaps with shoulder 252 and can brace against shoulder 252.

In the example shown, the inner seal 248 stays with the seal body 246 as the tip module 214 is disengaged from and dismounted from the spray control assembly 212. Inner seal 248 is not retained by the spray control assembly 212. The upstream face seal between inner seal 248 and valve housing 259 is formed during mounting of saddle seal portion 236 and is broken during dismounting of saddle seal portion 236. The upstream face seal between inner seal 248 and valve housing 259 is formed during mounting of tip module 214 and broken during dismounting of tip module 214.

Annular band 333 receives body projection 254 that extends in upstream direction UD. Annular band 333 can frictionally engage with body projection 254 of seal body 246 to retain inner seal 248 on seal body 246. It is understood that, in some examples, the inner seal 248 is symmetric about the axis SA such that a cross-section on the axis SA represents what the entire structure of inner seal 248 would look like.

Inner seal 248 further includes inner ring 332. Inner ring 332 extends in the upstream direction UD beyond both of the seal body 246 and the annular band 333. Inner ring 332 can include a flat upstream surface oriented in the upstream direction UD and that interfaces with a flat downstream surface of the valve assembly 222. Inner ring 332 is configured to form an annular face seal in the upstream direction UD. In the example shown, upstream face 306 is formed on an upstream side of inner ring 332 and is configured to interface with housing face 270 to seal against housing face 270. Inner ring 332 defines first part 320 of upstream flowpath 298.

In the example shown, housing face 270 does not include a recess (e.g., similar to recess 274) or a support ring (e.g., similar to support ring 272). As such, the valve housing 259 does not receive and does not radially overlap with portions of the inner seal 248, in the example shown. Inner seal 248 and valve housing 259 create an upstream face seal to maintain fluid within the tip flowpath 292 along axis SA. It is understood, however, that inner seal 248 can extend to radially overlap with valve housing 259 in various examples. For example, valve housing 259 can include a recess (e.g., a concavity) configured to receive a portion of inner seal 248, such as inner ring 332.

In the example shown, annular band 333 has thickness TB. The thickness TB can also be referred to as a width of annular band 333. In the example shown, the thickness TB is a radial width of annular band 333 as annular band 333 extends axially. In the example shown, inner ring 332 has axial thickness AT. In the example shown, the thickness TB of annular band 333 is less than the thickness AT of inner ring 332. The annular band 333 is radially thinner as compared to an axial thickness of the inner ring 332. Such a configuration can facilitate a compact configuration of saddle seal portion 236 radially outward from axis SA.

A downstream side of inner seal 248 interfaces with seal body 246 to form a fluid seal therebetween. In the example shown, inner ring 332 includes downstream face 308 formed as a flat surface oriented in the downstream direction DD and that engages with an axially oriented seal face 258 of seal body 246 to seal against seal body 246. In the example shown, inner ring 332 axially engages with the downstream end of body projection 254 to axially mate with seal body 246. The inner ring 332 can be considered to be clamped between seal body 246 and valve housing 259. In some examples, the inner ring 332 axially overlaps with a full radial extent of seal face 258 of the seal body 246.

Inner seal 248 is mounted to seal body 246 such that inner seal 248 sealingly engages with and forms an axial face seal with seal body 246 both when tip module 214 is mounted to spray control assembly 212 and when tip module 214 is dismounted from spray control assembly 212. Inner ring 332 interfaces with and contacts seal body 246 both when tip module 214 is mounted to spray control assembly 212 and when tip module 214 is dismounted from spray control assembly 212. Maintaining axial engagement between inner seal 248 and seal body 246 both when mounted and dismounted can prevent contaminants from entering between seal body 246 and inner seal 248, increasing operational life and reducing maintenance requirements.

In the example shown, inner seal 248 is formed as a monolithic body that is mounted to seal body 246 to be mounted and dismounted with tip module 214. Annular band 333 and inner ring 332 are formed as a single unit. In the example shown, annular elbow 335 joins annular band 333 and inner ring 332 to form the monolithic inner seal 248. Annular elbow 335 is sloped to extend axially and radially between the inner ring 332 and the annular band 333. Annular elbow 335 can be in contact with seal body 246 between inner ring 332 and annular band 333. In other examples, annular elbow 335 is partially in contact with seal body 246 and partially out of contact with the seal body 246.

Annular elbow 335 is bent between annular band 333 and inner ring 332. In the example shown, annular elbow 335 extends at an angle between annular band 333 and inner ring 332. Bend 336a is formed between inner ring 332 and annular elbow 335. Bend 336b is formed between annular band 333 and annular elbow 335. In the example shown, bend 336a and bend 336b are disposed such that the total bend between annular band 333 and inner ring 332 reorients the body of inner seal 248 from radial at inner ring 332 to axial at annular band 333. The total bend can be about 90-degrees. In some examples, the total bend is configured such that annular band 333 is disposed orthogonal to the inner ring 332. In the example shown, an angle of the first bend 336a is less than an angle of the second bend 336b when bend towards the downstream direction DD, the angle taken on an upstream side of inner seal 348. While annular elbow 335 is described as including multiple bends 336a, 336b, it is understood that, in some examples, annular elbow 335 can be formed as a single bend between annular band 333 and inner ring 332. For example, the single bend can form a 90-degree bend between annular band 333 and inner ring 332.

Inner ring 332 can define the first part 320 of the upstream flowpath 298 such that inner ring 332 is in contact with the spray fluid during spray operation. The inner ring 332 can be axially pinched between the seal body 246 and the housing face 270, to facilitate sealing therebetween. In the example shown, the inner ring 332 is axially pinched between seal body 246 and valve housing 259.

Inner seal 248 is wider downstream and narrower upstream on the exterior of inner seal 248. In the example shown, annular elbow 335 extends radially outward from inner ring 332 to annular band 333 and extends in downstream direction DD from inner ring 332 to annular band 333. As such, the exterior of the upstream end of inner seal 348 (e.g., at upstream face 306) has a smaller diameter relative to axis SA than the exterior of the downstream end of inner seal 248 (e.g., interfacing with shoulder 252). In the example shown, the exterior of inner seal 248 has a upstream diameter USD at an upstream-most end of inner seal 248 and the exterior of inner seal 248 has a downstream diameter DSD at a downstream end of inner seal 248. Upstream diameter USD is less than downstream diameter DSD.

In the example shown, the exterior of inner seal 248 has a largest exterior diameter at a location intermediate the upstream end and downstream end of inner seal 248. Bulge 338 is disposed intermediate the upstream and downstream ends of inner seal 248. Bulge 338 projects radially outwards relative to inner ring 332 and annular band 333. Bulge 338 can extend radially outward to engage with tip housing 228 and seal against tip housing 228. Bulge 338 extends fully annularly about axis SA. An interface between tip housing 228 and bulge 338 can assist in holding saddle seal portion 236 on tip housing 228. While inner seal 248 is shown as including bulge 338, it is understood that not all examples are so limited. In some examples, downstream diameter DSD is the largest exterior radial width of inner seal 248.

In the example shown, annular band 333 is isolated from spray fluid during spraying. The annular band 333 is not typically in contact with the spray fluid. The annular elbow 335 is also isolated from spray fluid during spraying. The portion of inner seal 248 defining first part 320 forms a radially narrowest interior portion of inner seal 248. The portion of inner seal 248 defining seal bore 310 has an interior diameter ID2. The portion of inner seal 248 extending over seal body 246 and surrounding and contacting a portion of seal body 246 to mount inner seal 248 to seal body 246 has an interior diameter ID1.

In the example shown, the largest diameter through upstream flowpath 298 is smaller than the diameter TD of the tunnel 280. In the example shown, the downstream inner diameter ID1 of inner seal 248 is larger than the diameter TD of the tunnel 280 while the upstream inner diameter ID2 of inner seal 248 is smaller than the diameter TD of the tunnel 280.

Inner seal 248 is configured such that the interior of inner seal 248 is narrower upstream and wider downstream. A narrowest portion of the interior of inner seal 248 defines the flowpath for the spray fluid between valve outlet aperture 276 and seal body 246. In the example shown, both the narrowest and widest openings through inner seal 248 axially overlap with seal body 246.

Inner seal 248 projects in upstream direction UD from seal body 246. In the example shown, inner seal 248 projects in upstream direction UD such that inner seal 248 extends axially out of tip housing bore 302. A portion of inner seal 248 is disposed such that that portion of inner seal 248 does not radially overlap with tip housing 228. The portion of inner seal 248 disposed axially outside of tip housing 228 interfaces with spray control assembly 212 to seal with spray control assembly 212. In the example shown, the upstream face 306 of inner ring 332 is disposed axially outside of tip housing bore 302. Inner seal 248 interfaces with seal body 246 at a location spaced axially from housing face 270 and inner seal 248 interfaces with valve housing 259 at a location spaced axially from seal body 246.

Inner seal 248 projecting axially outward of tip housing 228 axially spaces tip housing 228 from valve housing 259 along axis SA such that housing gap 312 is formed therebetween. Inner seal 248 bridges between tip housing 228 and valve housing 259 such that tip housing 228 is not directly in contact with valve housing 259. Preventing direct contact between tip housing 228 and valve housing 259 assists in concentric stacking of flow defining components by such components bracing and aligning against each other as opposed to the tip housing 228 and valve housing 259 interfacing to prevent desired seating. Preventing direct contact between tip housing 228 and valve housing 259 facilitates desired alignment of seal body 246, barrel 238, inner seal 248, etc. Preventing direct contact between the metallic valve housing 259 and metallic tip housing 228 also prevents wear on those components.

While inner seal 248 can project axially out of tip housing 228 in some examples, it is understood that not all examples are so limited. For example, inner seal 248 can be disposed such that upstream face 306 is aligned with the upstream end of tip housing 228. In other examples, inner seal 248 can be disposed fully upstream of the upstream end of tip housing 228 such that upstream face 306 is spaced in downstream direction DD from the upstream end of tip housing 228. In such an example, the inner seal 248 does not project axially out of the housing bore 302 in tip housing 228. In such examples, valve housing 259 can include a projection (e.g., similar to support ring 272 but without a recess or with a concave recess) that interfaces with inner seal 248 to space the interface between inner seal 248 and valve housing 259 in downstream direction DD from housing face 270. Such a configuration can space tip housing 228 axially from valve housing 259 to prevent contact therebetween.

Seal body 246 can be biased into contact with barrel 238 to seal against barrel 238. Inner seal 248 can bias seal body 246 in downstream direction DD along spray axis SA and towards tip axis TA. In the example shown, tip module 214 is mounted to spray control assembly 212 by a threaded interface between tip mount 230 and housing mount 224. Threading tip mount 230 to housing mount 224 displaces tip module 214 in upstream direction UD relative to valve housing 259, pressing inner seal 248 into valve housing 259 and causing inner seal 248 to exert an axial force on seal body 246 in downstream direction DD. Inner seal 248 is non-elastomeric and biases seal body 246 in downstream direction DD towards tip axis TA. The torque exerted on the threaded connection can directly affect the axial biasing force exerted on seal body 246. Such a configuration can maintain desired sealing between seal body 246 and barrel 238, even when spraying at relatively low pressures (e.g., less than about 200 psi) and with thin fluids (e.g., water). Mechanically biasing seal body 246 into contact with barrel 238 prevents leakage pathways from forming between seal body 246 and barrel 238.

Seal body 246 can directly contact barrel 238 to form a metal-to-metal seal therewith while not directly contacting the valve housing 259. Inner seal 248 is disposed directly axially between seal body 246 and valve housing 259. In the example shown, inner seal 248 can be considered to be sandwiched between seal body 246 and valve housing 259 while also being mounted to seal body 246.

In the example shown, inner seal 248 forms the downstream face seal with seal body 246 both with tip module 214 mounted to spray control assembly 212 and tip module 214 dismounted from spray control assembly 212. In the example shown, inner seal 248 forms the upstream face seal with valve housing 259 with tip module 214 mounted to spray control assembly 212. In the example shown, a largest diameter of the first part 320 defined by inner seal 248 is smaller than a diameter of the upstream-most end of seal body 248 (e.g., smaller than a diameter of seal face 258).

Inner seal 248 provides a spacer between seal body 246 and valve housing 259 to prevent contact therebetween. The spacer formed by inner seal 248 is non-elastomeric and inner seal 248 is configured to not crush between seal body 246 and valve housing 259. The inner seal 248 may be compressed less than 5%, less than 3%, less than 1%, less than 0.5%, or less of its axial thickness AT of the inner ring 332 when sandwiched between seal body 246 and valve housing 259 such that inner seal 248 exerts axial biasing force on both seal body 246 and valve housing 259.

In the example shown, seal body 246 extends radially inward of the surface of inner ring 332 defining first part 320 (e.g., by body bore 256 being narrower than seal bore 310). Housing face 270 does not similarly project radially inward to axially overlap with first part 320. As such, seal body 246 axially overlaps with seal bore310 and housing face 270 does not axially overlap with seal bore 310.

In the example shown, inner seal 248 is disposed axially between seal body 246 and housing face 270 such that seal body 246 and housing face 270 do not directly oppose each other along the axis SA. Inner ring 332 is disposed directly axially between seal body 246 and housing face 270 such that the portions of one of seal body 246 and housing face 270 that do not axially overlap with inner seal 248 (e.g., by extending radially inward of the surface defining seal bore 310) also do not axially overlap with the other one of seal body 246 and housing face 270.

Inner seal 248 defines first part 320 of upstream flowpath and can be directly exposed to spray fluid flowing through first part 320. Inner seal 248 is non-elastomeric such that inner seal 248 is solvent resistant. Inner seal 248 can be utilized during spraying of solvents, unlike elastomeric seals. Inner seal 248 routes spray fluid between valve housing 259 and seal body 246. Upstream flowpath 298 through saddle seal portion 236 does not include expansion pockets and routes the spray fluid to downstream flowpath 294 through spray tip 226 for spraying through spray orifice 234. The spray fluid enters downstream flowpath 294 through tip inlet 296 and exits through spray orifice 234.

Saddle seal portion 236 provides significant advantages. Inner seal 248 is mounted on seal body 246 such that inner seal 248 mounts to spray control assembly 212 with other components of tip module 214 and dismounts from spray control assembly 212 with other components of tip module 214. Seal body 246 is received at least partially into a seal chamber 330 defined by inner seal 248 such that inner seal 248 mounts to and is supported by seal body 246. Inner seal 248 mounts on seal body 246 to ride with seal body 246 during mounting and dismounting.

Inner ring 332 is configured to be clamped axially between seal body 246 and housing face 270 to form a face seal with both seal body 246 and housing face 270. Inner ring 332 defines first part 320 that conveys spray fluid from valve 278 to seal body 246. First part 320 directs the spray fluid to second part 322 and eliminates expansion chambers that extend radially outward in the axial space between seal body 246 and valve housing 259. Inner seal 248 eliminates such expansion chambers and may thus minimizes or eliminates echoes of pressure waves. Such elimination supports more even fluid flow and spray atomization, resulting in smoother coating being sprayed with fewer irregularities. Inner seal 248 can be formed from a non-elastomeric material, such as non-elastomeric polymer, which may further reduces echoes of pressure waves. Such pressure waves may travel through elastomeric material and echo off walls. Non-elastomeric polymers may resist such propagation of pressure wave echoes. Non-elastomeric polymers further facilitate spraying of solvents. In some examples, no portion of upstream flowpath 298 is defined by elastomer.

Inner seal 248 bridges between seal body 246 and valve housing 259. Inner seal 248 can mechanically bias seal body 246 into engagement with barrel 238 to inhibit leakage therebetween and provide for more even spraying and consistent atomization, even at low pressures and/or with thin spray fluids (e.g., water-based spray fluids).

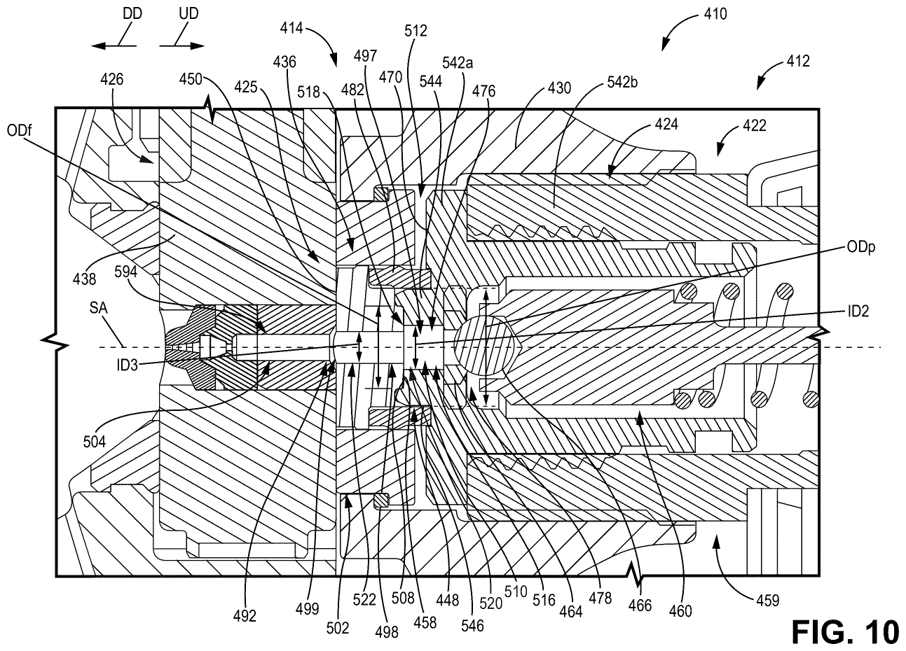

FIG. 10 is a cross-sectional view cross-sectional view of portion of a spray gun 410 showing an interface between a tip module 414 and spray control assembly 412. Spray gun 410 is substantively similar to spray gun 10 (best seen in FIGS. 1 and 2) and spray gun 210 (best seen in FIGS. 7 and 8) except that inner seal 448 is formed by valve housing 459. Tip assembly 425 is substantively similar to tip assembly 25 (best seen in FIGS. 3A-5A) and tip assembly 225 (best seen in FIG. 9A) except that inner seal 448 is formed by valve housing 459.

Components of spray gun 410 that are similar to components of spray gun 10 have the same reference numbers except increased by “400” (e.g., spray gun 10 and spray gun 410). Components of spray gun 410 that are similar to components of spray gun 210 have the same reference numbers except increased by “200” (e.g., spray gun 210 and spray gun 410). Aspects of common reference numbers but increased by the indicated amount can be the same as between examples unless clearly shown or described to be different. Aspects from one example can be implemented in the other examples such that aspects from these two or more different examples can be readily swapped in any combination. As such, common aspects may not be repeated as between the multiple examples for the sake of brevity and may not be discussed or labeled in later examples for the sake of brevity.

Valve assembly 422 includes valve housing 459 that is formed by housing body 542a and housing body 542b that are connected together. In the example shown, the housing body 542a is connected to housing body 542b by interfaced threading formed therebetween. Housing body 542a includes exterior threading configured to interface with interior threading on housing body 542b. Housing mount 424 is formed on housing body 542b. While housing body 542a is shown as threadedly connected to housing body 542b, it is understood that not all examples are so limited. Housing body 542a and housing body 542b can be connected in any desired manner, such as by one or more of press-fitting, welding, swaging, threading, adhesive, etc.

Housing body 542a is formed separate from housing body 542b in the example shown. It is understood, however, that not all examples are so limited. In some examples, housing bodies 542a, 542b can be monolithically formed such that the downstream portion of valve housing 459 that extends to tip module 414 and outputs spray fluid to tip assembly 425 is monolithically formed. Housing body 542a supports seat 464. Needle 460 extends into housing body 542a such that needle 460, housing body 542a, and housing body 542b all radially overlap each other at least one location along axis SA. Valve 478 is disposed within housing body 542a and ball 466 interfaces with seat 464 radially within housing body 542a.

Housing body 542a is formed from a non-elastomeric material. For example, housing body 542a can be formed from a non-elastomeric polymer, metal, etc. Housing body 542b is formed from a metal to directly interface with the metallic tip mount 430, though it is understood that other configurations are possible. In the example shown, the housing face 470 is formed by the non-elastomeric material of housing body 542a. The housing face 470 can be formed by non-elastomeric polymer. In some examples, housing body 542a is formed from non-elastomeric polymer and housing body 542b is metallic.

Outer ring 482 extends between seal body 446 and valve housing 459. Outer ring 482 can be formed from elastomeric material, among other options. Outer ring 482 can provide a backup seal to inner seal 448.

Saddle seal portion 436 is configured to receive spray fluid into tip flowpath 492 through tip assembly 425. In the example shown, the main tip pathway 492 including the upstream flowpath 498 and the pre-wall path portion 504 does not include an expansion pocket, the expansion pocket defined as any radial chamber having an average inner diameter greater than two times of an average inner diameter of a total remainder of the tip pathway 492 and having an axial length less than one third of an axial length of the tip pathway 492.

Saddle seal portion 436 receives spray fluid output from valve 478 and fluidly connects valve 478 and the downstream flowpath 494 through spray tip 426. Saddle seal portion 436 defines upstream flowpath 498. Upstream flowpath 498 extends between portion inlet 497 and portion outlet 499. Saddle seal portion 436 receives spray fluid through portion inlet 497 and outputs the spray fluid through portion outlet 499. Portion inlet 497 is defined by inner seal 448 and portion outlet 499 is defined by seal body 446. Portion inlet 497 is formed though an upstream end of inner seal 448. In the example shown, the portion inlet 497 can be considered to be formed at a location within the bore through housing body 542a that is at least partially defined by projection 544. Portion outlet 499 is formed through saddle face 450. Upstream flowpath 498 extends along axis SA. Axis SA extends through upstream flowpath 498. Upstream flowpath 498 can be disposed coaxially with valve outlet aperture 476. First part 520 and valve outlet aperture 476 are both defined by valve housing 459 in the example shown.

Inner seal 448 is formed by a portion of housing body 542a. Inner seal 448 defines at least a part of an upstream end of saddle seal portion 436. In the example shown, inner seal 448 is formed by projection 544 that extends in downstream direction DD from housing face 470 of valve housing 459. Projection 544 can be a cylindrical projection, among other options. First part 520 is formed radially within projection 544. In the example shown, projection 544 defines seal bore 510. First part 520 is formed through seal bore 510. In the example shown, the valve housing 459 and inner seal 448 are monolithic to define the valve outlet aperture 476 and the first part 520. Outlet orifice 518 is formed through the downstream end of projection 544. The inlet orifice 516 can be considered to be disposed at a location within the bore through valve housing 459 that extends between the valve chamber 528 and outlet orifice 518.

Saddle face 450 of seal body 446 is configured to interface with barrel 438 to seal against barrel 438 and form a metal-to-metal interface at a downstream end of saddle seal portion 436. Seal body 446 directly interfaces with inner seal 448 to seal against inner seal 448. In the example shown, seal face 458 of seal body 446 contacts and interfaces with the downstream face 508 of projection 544 oriented in downstream direction DD. A downstream face seal is formed between inner seal 448 and seal body 446. Downstream face 508 can extend radially outward of the radially outer edge of the portion of seal body 446 engaging with downstream face 508. Projection 544 can be disposed such that a portion of downstream face 508 does not axially overlap with seal face 458. The portion of downstream face 508 not axially overlapping with seal face 458 can be extend radially inward of seal face 458 and/or radially outward of seal face 458.

In the example shown, projection 544 has outer diameter ODp and seal body 446 has outer diameter ODf at the upstream end of seal body 446. For example, seal face 458 can have outer diameter ODf. An outer diameter of the projection 544 is larger than an outer diameter of the seal face 458 at the upstream end of seal body 446. The downstream face 508 extending radially outward of seal face 458 can assist in concentric alignment and sealing between seal body 446 and inner seal 448. In the example shown the outer diameter ODp of projection 544, which is also the outer diameter of inner seal 448, is larger than the outer diameter ODf. It is understood, however, that not all examples are so limited. In the example shown, the outer diameter ODp of projection 544 is smaller than a diameter HD of the housing bore 502 through tip housing 428. In the example shown, projection 544 extends into tip housing 428 such that at least a portion of projection 544 radially overlaps with tip housing 428.

Inner seal 448 extends in downstream direction DD from housing face 470 such that the interface between inner seal 448 and seal body 446 is spaced axially from housing face 470. In the example shown, housing face 470 projects radially outward from a base 546 of the projection 544. Housing face 470 axially overlaps with structure of tip housing 428 and is spaced axially from the tip housing 428 by the projection 544 interfacing with the seal body 446 such that housing gap 512 is formed between the housing face 470 and the upstream end of tip housing 428.

In the example shown, downstream face 508 forms a downstream-most structure of valve housing 459. The portion of valve housing 459 that interfaces with seal body 446 is disposed further downstream than any other structure of valve housing 459 in the example shown. No portion of valve housing 459 radially overlaps with the face seal between seal body 446 and inner seal 448 in the example shown, it being understood that not all examples are so limited.

The housing body 542a can be disposed such that seal body 446 forms the only metallic portion of tip module 414 contacted by housing body 542a. In the example shown, seal body 446 forms the only portion of tip module 414 contacted by housing body 542a. Spacing the interface between inner seal 448 and seal body 446 in downstream direction from housing face 470 generates housing gap 512 axially between tip housing 428 and valve housing 459 while seal body 446 engages with and presses into inner seal 448.

Inner seal 448 bridges between tip housing 428 and the portions of valve housing 459 axially overlapping with tip housing 428 such that tip housing 428 is not directly in contact with valve housing 459. Preventing direct contact between tip housing 428 and valve housing 459 assists in concentric stacking of flow defining components. Preventing direct contact between tip housing 428 and valve housing 459 facilitates desired alignment of seal body 446, barrel 438, inner seal 448, etc. Preventing direct contact between the non-elastomeric housing body 542a and metallic tip housing 428 also prevents wear on those components.

The respective diameters of the first part 520 and the second part 522 can be the same or can be different. The respective inner diameters may be no more different than 115% relative to each other. The respective inner diameters may be no more different than 150% relative to each other. The respective inner diameters may be no more different than 200% relative to each other.

In some examples, the respective diameters ID2, ID3 of first part 520 and second part 522 can be variable along the length of first part 520 and/or second part 522. In some examples, an average inner diameter of the first part 520 and an average inner diameter of the second part 522 may be no more different than 115% relative to each other. The average inner diameter of the first part 520 and the average inner diameter of the second part 522 may be no more different than 150% relative to each other. The average inner diameter of the first part 520 and the average inner diameter of the second part 522 may be no more different than 200% relative to each other.

In some examples, a minimum (i.e., smallest) inner diameter of the first part 520 and a minimum inner diameter of the second part 522 may be no more different than 115% relative to each other. The minimum inner diameter of the first part 520 and the minimum inner diameter of the second part 522 may be no more different than 150% relative to each other. The minimum inner diameter of the first part 520 and the minimum inner diameter of the second part 522 may be no more different than 200% relative to each other.

In some examples, a minimum inner diameter of the first part 520 and a maximum (i.e., largest) inner diameter of the second part 522 may be no more different than 115% relative to each other. The minimum inner diameter of the first part 520 and the maximum inner diameter of the second part 522 may be no more different than 150% relative to each other. The minimum inner diameter of the first part 520 and the maximum inner diameter of the second part 522 may be no more different than 200% relative to each other.

In some examples, a maximum inner diameter of the first part 520 and a minimum inner diameter of the second part 522 may be no more different than 115% relative to each other. The maximum inner diameter of the first part 520 and the minimum inner diameter of the second part 522 may be no more different than 150% relative to each other. The maximum inner diameter of the first part 520 and the minimum inner diameter of the second part 522 may be no more different than 200% relative to each other.

Inner seal 448 being formed by valve housing 459 provides significant advantages. Inner seal 448 is monolithic with a portion of valve housing 459 reduces part count and eliminates a separately formed inner seal 448. Seal body 446 engages directly with valve housing 459 such that no axial gap is formed between seal face 458 of seal body 446 and valve housing 459. Such direct engagement eliminates expansion chambers and jet outs that may lead to pressure echoes, elimination of which may improve flow characteristics and atomization. The non-elastomeric material of inner seal 448 may further reduce pressure echoes. Inner seal 448 is solvent resistant such that the non-elastomeric material of inner seal 448 facilitates spraying of solvents.

In some examples, a tip assembly is configured similar to a combination of the examples shown in FIGS. 7-9B and 10. For example, the valve housing can include a projection (similar to projection) and the inner seal 248 (FIGS. 9A and 9B) can interface with the projection to form the upstream face seal between the inner seal 248 and the valve housing including the projection. The valve housing can be monolithic and can be metallic and the inner seal 248 can interface with that valve housing (e.g., valve housing 259 with projection 544).

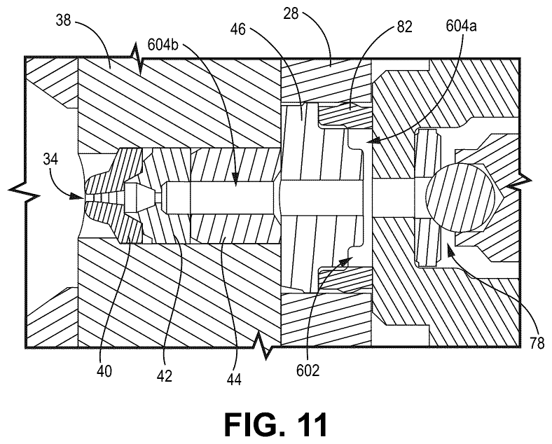

FIG. 11 is a cross-sectional view of a tip assembly 625 that includes outer ring 82 but not an inner seal. Outer ring 82 is not closely fit about the inner diameter of the valve outlet aperture or the inner diameter of the inlet aperture of the seal body 46. Outer ring 82 not being closely fit to define a first part (e.g., first part 120, 320, 520) that bridges between a valve outlet aperture and the inlet aperture of seal body 46 allows for significant radial expansion and creation of an expansion pocket 602 along the flow path of the spray fluid.

An upstream location 604a along the flowpath and a downstream location 604b along the flowpath are indicated in FIG. 11. The diameter of the flowpath at downstream location 604b is much smaller than the diameter of the flow path at upstream location 604a. Pressure waves, such as those created by the opening or closing of the valve 78 and/or by cycles of the pressure generating fluid displacer (e.g., piston or diaphragm) moving to generate the pressure, can reverberate within the expansion pocket 602 of upstream location 604a to cause pressure echoes and store fluid. The examples shown in FIGS. 1-10 eliminate such an expansion pocket 602 and thus minimize or eliminate echoes of pressure waves. Such elimination supports more even fluid flow and spray atomization, resulting in smoother coating being sprayed with fewer irregularities. The expansion pocket 602 is directly radially outward from the axis SA and formed such that structure of the seal body 46 exists directly radially between the axis SA and the radial expansion pocket 602. The expansion pocket 602 can also be referred to as a radial expansion chamber.

Saddle seal portions 36, 236, 336 provide significant advantages. The inner seals 48, 248, 448 form an axially oriented face seal with the seal body and bridge between the seal body and the valve housing. The inner seal 48, 248, 448 is disposed directly axially between the seal body and a housing face. The inner seals 48, 248, 448 define first parts of upstream flowpaths. The non-elastomeric inner seals 48, 248, 448 may further reduce echoes of pressure waves as such pressure waves may travel through elastomeric material and echo off walls while non-elastomeric polymers may resist such propagation of pressure wave echoes. The relative diameters through the first parts 120, 320, 520 and second parts 122, 322, 522 are sized to eliminate the formation of expansion pocket 602, providing for generation of smooth fluid flow and application of a smooth coat of atomized spray fluid. Saddle seal portions 36, 236, 436 eliminate the formation of the expansion pocket 602 such that the upstream flowpath does not include the expansion pocket 602. In the examples of FIGS. 1-10 the seal body is not radially overlapped by portions of the tip flowpath and as such material of the seal body is not disposed radially between the axis SA and the spray fluid through the tip flowpath, unlike the example shown in FIG. 11.

While the invention(s) has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention(s) without departing from the essential scope thereof. Therefore, it is intended that the invention(s) not be limited to the particular embodiment(s) disclosed, but that the invention(s) may include all embodiments falling within the scope of the appended claims. Any single feature, or any combination of features from one embodiment show herein, may be utilized in a different embodiment independent from the other features shown in the embodiment herein. Accordingly, the scope of the invention(s) and any claims thereto are not limited to the particular to the embodiments and/or combinations of the features shown herein, but rather can include any combination of one, two, or more features shown herein.

1.-92. (canceled)

93. A spray tip assembly through which a spray coating flows along an axis from an upstream direction to a downstream direction, the spray tip assembly comprising:
a spray tip, the spray tip comprising a barrel and a tunnel extending transversely through the barrel, a downstream flow path extending within the tunnel, the downstream flow path defined in part by a tip piece located within the tunnel, the tip piece forming an outlet orifice that atomizes spray fluid, the downstream flow path having an spray tip inlet, the downstream flow path aligned along the axis such that the axis extends through the downstream flow path, and the spray tip rotatable to reverse a direction of flow through the downstream flow path for clog removal; and
a saddle seal portion having an upstream end, a downstream end, and an upstream flow path extending through the s addle seal portion from a portion inlet on the upstream end to a portion outlet on the downstream end, the upstream flow path aligned along the axis such that the axis extends through the upstream flow path, the saddle seal portion comprising:
a seal body, wherein the seal body is metallic; and
an inner seal in contact with the seal body, wherein the inner seal is non-elastomeric;
the inner seal defining a first part of the upstream flow path and at least part of the upstream end, the seal body defining a second part of the upstream flow path disposed downstream of the first part of the upstream flowpath;
the downstream end comprising a saddle surface that mates to the barrel to cover the spray tip inlet and fluidly connect the upstream flow path to the spray tip inlet, the saddle surface remaining engaged with the barrel as the spray tip is rotated for clog removal.

94. The spray tip assembly of claim 93, wherein a largest inner diameter of the upstream flow path is no greater than two times a smallest inner diameter of the upstream flow path.

95. The spray tip assembly of claim 93, wherein a largest inner diameter of the first part of the upstream flow path is smaller than a largest inner diameter of the tunnel.

96. The spray tip assembly of claim 93, wherein the upstream flow path does not include a radial expansion pocket, whereby the radial expansion pocket is directly radially outward from the axis and formed such that structure of the seal body exists directly radially between the axis and the radial expansion pocket.

97. The spray tip assembly of claim 93, wherein a diameter of a seal bore through the inner ring is larger than a diameter of a body bore through the seal body, the seal bore defining the first part and the body bore defining the second part.

98. The spray tip assembly of claim 93, wherein the inner ring axially overlaps with a portion of an upstream face of the seal body.

99. The spray gun of claim 93, wherein a body projection of the seal body extends in the upstream direction, and a seal face disposed at an upstream end of the body projection interfaces with the inner seal to form a downstream face seal.

100. The spray gun of claim 99, wherein an outer diameter of the seal face is smaller than an outer diameter of the inner seal.

101. The spray gun of claim 99, wherein at least a portion of a downstream face of the inner seal is not axially overlapped by the seal face.

102. The spray tip assembly of claim 93, further comprising:
an orifice wall within the tunnel, the orifice wall extending radially inward to form a flow restriction which narrows the downstream flow path along the orifice wall to be narrower than any part of the upstream flow path, the downstream flow path including a pre-wall path portion beginning at the spray tip inlet and terminating at the orifice wall.

103. The spray tip assembly of claim 102, further comprising:
a main flow path including the upstream flow path and the pre-wall path portion, wherein the main flow path does not include an expansion chamber, the expansion chamber defined as any radial chamber having an average inner diameter greater than two times of an average inner diameter of a total remainder of the main flow path and having an axial length less than one third of an axial length of the main flow path.

104. The spray tip assembly of claim 102, wherein a largest inner diameter of the first part of the upstream flow path is no greater than two and a half times of a largest inner diameter of the pre-wall path portion.

105. The spray tip assembly of claim 104, wherein the largest inner diameter of the first part is no greater than one and a half times of the largest inner diameter of the pre-wall path portion.

106. The spray tip assembly of claim 102, wherein an average inner diameter along an entire length of the first part of the upstream flow path is no greater than two and a half times of an average inner diameter along an entire length of the pre-wall path portion.

107. The spray tip assembly of claim 106, wherein the average inner diameter along the entire length of the first part is no greater than one and a half times of the average inner diameter along the entire length of the pre-wall path portion.

108. A spray tip module comprising:
a tip housing defining a barrel bore extending along a mount axis and defining a housing bore extending fully through the tip housing along the flow axis and transversely through the barrel bore;
the spray tip assembly of claim 93, wherein the spray tip is rotatably mountable in the barrel bore and the saddle seal portion is disposed within the housing bore at a location upstream of the barrel bore.

109. A spray gun comprising:
a gun body;
a trigger;
a valve assembly having a valve that opens to release spray fluid and closes to block spray fluid, the valve assembly comprising a valve outlet aperture disposed downstream of the valve; and
the spray tip assembly of claim 93, further comprising a spray tip housing configured to support the spray tip and at least the seal body of the saddle seal portion;
wherein the inner seal seals with the valve assembly about the valve outlet aperture.

110. The spray gun of claim 109, wherein a valve housing of the valve assembly comprises a recess, the inner seal being received within the recess to form an annular face seal with the valve housing about the valve outlet aperture, the inner seal circumferentially supported by a support ring that at least partially defines the recess to limit radial expansion of the inner seal and that extends in the downstream direction from a housing face of the valve housing.

111. The spray gun of claim 110, wherein an outer diameter of the support ring is smaller than a housing bore through the tip housing within which the seal body is mounted.

112. A spray gun through which a spray coating flows along a spray axis from an upstream direction to a downstream direction, the spray gun comprising:
a gun body;
a trigger;
a valve assembly including a valve which opens to release spray fluid and closes to block spray fluid, the valve assembly comprising a downstream end, a valve outlet aperture located on the downstream end, and a recess formed on the downstream end;
a tip housing having a housing bore extending along the spray axis;
a spray tip, the spray tip comprising a barrel and a tunnel extending transversely through the barrel, a downstream flowpath extending within the tunnel, the downstream flowpath defined in part by a tip piece located within the tunnel, the tip piece forming an outlet orifice that atomizes spray fluid, the downstream flowpath having a spray tip inlet, the downstream flowpath aligned along the spray axis such that the spray axis extends through the downstream flowpath, the barrel insertable into the tip housing, the spray tip rotatable while the barrel is within the tip housing to reverse a direction of flow through the downstream flowpath for clog removal;
an inner seal received within the recess of the valve assembly, the inner seal defining a first part of an upstream flowpath, the inner seal formed from a non-elastomeric polymer; and
a seal body, the seal body defining a second part of the upstream flowpath disposed downstream of the first part of the upstream flowpath, the seal body comprising a saddle surface that mates to the barrel to cover the spray tip inlet and fluidly connect the first part of the upstream flowpath to the spray tip inlet, the saddle surface remaining engaged with the barrel as the spray tip is rotated for clog removal;
wherein the inner seal forms a downstream face seal with the seal body to form a fluid channel for the spray fluid from the valve outlet orifice, sequentially through each of the first part of the upstream flowpath, the second part of the upstream flowpath, the downstream flowpath, and out the outlet orifice; and
wherein the inner seal is retained in the recess of the valve assembly upon separation of the seal body and the inner seal during dismounting of the tip housing.
